(19) United States
(12) Patent Application Publication
(10) Pub. No.: US 2025/0272485 A1
(43) Pub. Date: Aug. 28, 2025

(54) DEEP LEARNING SYSTEM FOR NAVIGATING FEEDBACK

(71) Applicant: Google LLC, Mountain View, CA (US)

(72) Inventors: Hamza Harkous, Zürich (CH); Sai Teja Peddinti, Milpitas (CA); Rishabh Khandelwal, Madison, WI (US); Animesh Srivastava, Mountain View, CA (US); Nina Taft, Mountain View, CA (US); Elisabetta Eleonora Susanna Alazraki, London (GB)

(21) Appl. No.: 18/855,262

(22) PCT Filed: Oct. 20, 2022
(86) PCT No.: PCT/US2022/078443

§ 371 Date: Oct. 8, 2024

Related U.S. Application Data
(60) Provisional application No. 63/365,071, filed on May 20, 2022.

(51) Int. Cl. G06F 40/20

(52) U.S. Cl. CPC G06F 40/20

(57) ABSTRACT

A method using a computing system is described that classifies each feedback text from a plurality of feedback texts into one or more categories. The method dynamically generates, using the plurality of feedback texts, a set of feedback text issues. The set of feedback text issues includes one or more issues associated with each feedback text from the plurality of feedback texts. The method dynamically generates, using the set of feedback text issues, one or more themes associated with the plurality of feedback texts. Each of the one or more themes is associated with a respective subset of feedback text issues from the set of feedback text issues. The method outputs a graphical user interface that includes one or more from the group consisting of at least one feedback text issue from the set of feedback text issues, and at least on theme from the one or more themes.

### BACKGROUND

Computing devices may download applications from app stores (or application marketplaces) to extend the functionality of the computing devices. An app store is a type of digital distribution platform for applications. They typically allow users to provide reviews to give feedback on the application and help others decide which applications to try. The application developer typically has access to these reviews and may use them to improve their applications.

### SUMMARY

In general, techniques of this disclosure are directed to extracting, processing, and understanding feedback texts, such as application reviews, to enable developers to understand the issues with the applications and take concrete steps to update their applications. Feedback texts are generally collected in an unstructured free-text form, which is challenging to understand at scale. The techniques of this disclosure may use deep learning models trained on different tasks, such as privacy feedback classification, privacy issues generation, and high-level theme creation to summarize feedback, starting from unstructured text and resulting in a hierarchy of high-level issue themes and fine-grained issues within each theme, alongside representative reviews for each issue.

In one example, the disclosure is directed to a method that includes classifying, by a computing system, each feedback text from a plurality of feedback texts into one or more categories; dynamically generating, by the computing system and using the plurality of feedback texts, a set of feedback text issues, wherein the set of feedback text issues includes one or more issues associated with each feedback text from the plurality of feedback texts; dynamically generating, by the computing system and using the set of feedback text issues, one or more themes associated with the plurality of feedback texts, wherein each of the one or more themes is associated with a respective subset of feedback text issues from the set of feedback text issues; and outputting, by the computing system and for display, a graphical user interface that includes one or more from the group consisting of at least one feedback text issue from the set of feedback text issues, and at least one theme from the one or more themes.

In another example, the disclosure is directed to a computing system that includes one or more processors; and a memory that stores instructions that, when executed by the one or more processors, cause the one or more processors to classify each feedback text from a plurality of feedback texts into one or more categories; dynamically generate a set of feedback text issues, wherein the set of feedback text issues includes one or more issues associated with each feedback text from the plurality of feedback texts; dynamically generate using the set of feedback text issues, one or more themes associated with the plurality of feedback texts, wherein each of the one or more themes is associated with a respective subset of feedback text issues from the set of feedback text issues; and output for display, a graphical user interface that includes one or more from the group consisting of at least one feedback text issue from the set of feedback text issues, and at least one theme from the one or more themes

In another example, the disclosure is directed to a non-transitory computer-readable storage medium storing instructions that, when executed, cause one or more processors of a computing system to classify each feedback text from a plurality of feedback texts into one or more categories; dynamically generate a set of feedback text issues, wherein the set of feedback text issues includes one or more issues associated with each feedback text from the plurality of feedback texts; dynamically generate using the set of feedback text issues, one or more themes associated with the plurality of feedback texts, wherein each of the one or more themes is associated with a respective subset of feedback text issues from the set of feedback text issues; and output for display, a graphical user interface that includes one or more from the group consisting of at least one feedback text issue from the set of feedback text issues, and at least one theme from the one or more themes.

The details of one or more examples of the disclosure are set forth in the accompanying drawings and the description below. Other features, objects, and advantages of the disclosure will be apparent from the description and drawings, and from the claims.

### BRIEF DESCRIPTION OF THE FIGURES

FIG. 1 is a conceptual diagram illustrating the main pipeline components and expected outputs, in accordance with one or more techniques of this disclosure.

FIG. 2 is a block diagram illustrating an example computing system for extracting, processing, and understanding reviews, in accordance with one or more aspects of the present disclosure.

FIGS. 3A-3D are conceptual diagrams illustrating aspects of an example machine-learned model according to example implementations of the present disclosure.

FIG. 4 is a conceptual diagram illustrating a modeling approach in accordance with one or more techniques of this disclosure.

FIG. 5 is a conceptual diagram illustrating various steps for building a privacy feedback classifier, in accordance with one or more techniques of this disclosure.

FIG. 6A is a conceptual diagram illustrating an example issue grouping and theme title creation process, in accordance with one or more techniques of this disclosure.

FIG. 6B is a conceptual diagram illustrating an example of issue generation using an issue retrieval module, in accordance with one or more techniques of this disclosure.

FIG. 7 is a conceptual diagram illustrating an example of the hierarchy produced by a system implementing one or more techniques of this disclosure.

FIG. 8 is a conceptual diagram illustrating the evolution of issues over time, in accordance with one or more techniques of this disclosure.

FIG. 9 is a conceptual diagram illustrating an example graphical user interface that includes information generated by analyzing feedback texts, in accordance with one or more techniques of this disclosure.

FIG. 10 is a flow diagram illustrating example operations of a process that is performed by a computing system in accordance with one or more aspects of the present disclosure.

### DETAILED DESCRIPTION

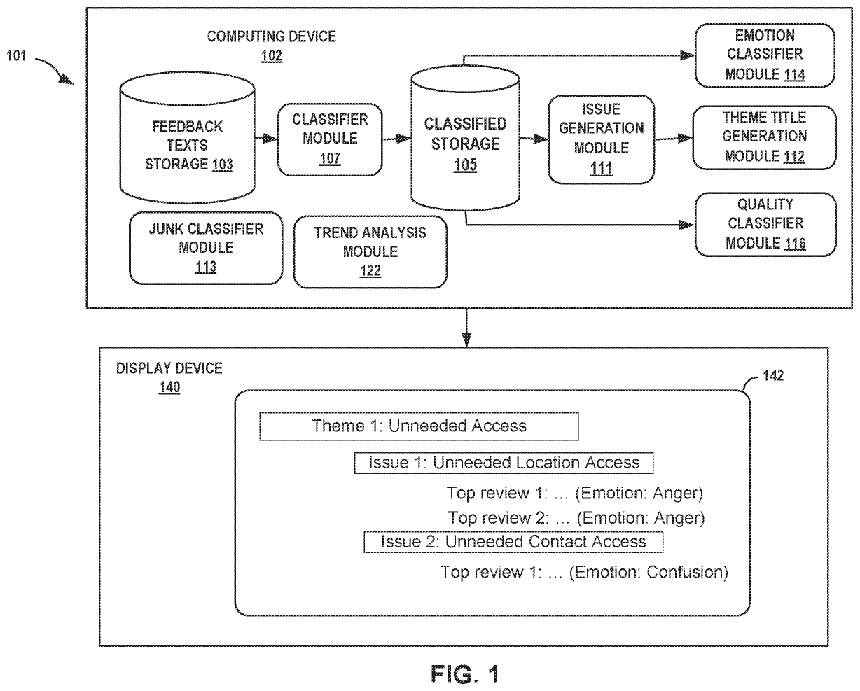

FIG. 1 is a conceptual diagram illustrating the main pipeline components and expected outputs, in accordance with one or more techniques of this disclosure. While the techniques of this disclosure are described with respect to privacy considerations, the techniques may be applied to other user concerns or feedback, such as security, accessibility, application bugs, application performance issues, application feature requests, positive features of applications, etc.

Computing system 101 includes computing device 102 and display device 140. Computing device 102 may be a cloud-based system that runs one or more machine learning models, such as deep learning models, trained on different tasks. Computing device 102 may classify feedback texts, determine a number of issues from the classified feedback texts, and generate themes from the issues. Feedback texts may be reviews, such as application reviews. Graphical user interface (GUI) 142 at display device 140 may use the issues and themes to display feedback texts in a structured manner, allowing application designers and others to understand the feedback texts better.

Applications may receive a large number of reviews that make it difficult for developers to review. Computing device 102 may help developers sift through privacy reviews in meaningful ways. Computing device 102 may allow for:
topical diversity: A high coverage of the various aspects in the privacy domain is provided regardless of the way they are linguistically expressed.
glanceability: The gist of the topics is accessible without having to read all reviews.
navigability: A high-level understanding is available with the ability to dive deep into the issues.

Previous attempts at analyzing reviews have primarily relied on a keyword-based sampling of training data, thus restricting the privacy issues to a restricted set of predefined wordings. Moreover, these approaches did not go further beyond the classification step. Hence, they fail to create a structure out of the reviews. Even when considering the broader work on analyzing app reviews, these fall short at providing glanceable summaries of the topics that users raise. They are often restricted to extracting verbatim keywords or phrases from users' reviews. The ultimate result these approaches achieve is a set of clustered reviews, without an explainable common theme for each cluster. This results in a lot of manual work for navigating through reviews by reading them, finding issues users discuss, and understanding the high-level themes summarizing users' privacy feedback. Computing device 102 may generate issues and themes from the feedback texts without requiring hand labeling and the issues and themes may be found automatically and early in a review process.

According to the techniques of this disclosure, computing system 101 may provide for end-to-end retrieval and analysis of privacy-related feedback and may leverage state-of-the-art techniques in Natural Language Processing (NLP) to provide reviews that are presented to developers at multiple levels of abstraction. To satisfy topical diversity, the feedback classifier may leverage a Natural Language Inference (NLI) task to ensure that the training data has high coverage of the privacy concepts defined in widely used privacy taxonomies.

Junk classifier module 113 may apply a machine-learned model (e.g., a T5 model trained using junk feedback texts) to remove junk feedback texts from a large corpus of feedback texts. Junk classifier module 113 may label feedback text as being junk if the data is spammy or the user is unauthenticated or unreliable. As one example, review data includes three reviews, “Company, why don't you love me?” “Hahahahah! ljioda fodasfijadio,” and “I can't delete my application history.” Junk classifier module 113, in response to receiving the three reviews as input, may classify “Company, why don't you love me?” and “Hahahahah! ljioda fodasfijadio” as “junk” while classifying “I can't delete my application history” as “clean.” In various instances, only feedback texts classified as “clean” may be used as input to classifier module 107. That is, junk classifier module 113 may be applied to the feedback texts included in feedback text storage 103 to filter or otherwise remove junk feedback texts, which may result in higher quality information generated by the review analysis system described herein.

Feedback text storage 103 may store a plurality of feedback texts for an application. Feedback texts may be comments provided by users of an application. The feedback texts may be filtered using junk classifier module 113 to remove junk feedback texts before processing.

The feedback texts and other data used by computing device 102 may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server. In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content that may be more relevant to the user.

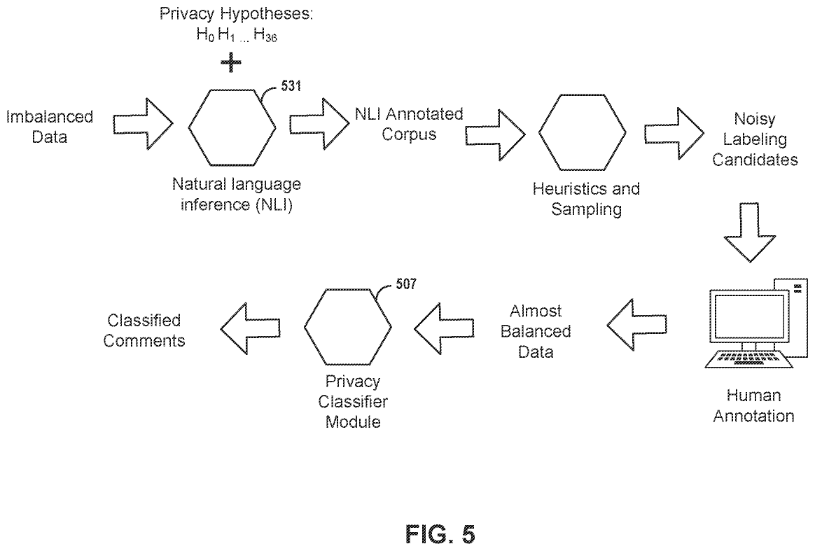

Classifier module 107 may classify the feedback texts. The training of an exemplary classifier is described below with respect to FIG. 5. Classifier module 107 may use a machine learning model such as a natural language processing (NLP) model (e.g., a transformer model, a recurrent neural network (RNN) model, etc.) In one example, classifier module 107 may use a T5 (Text-to-Text Transfer Transformer) model.

Classifier module 107 may associate feedback texts with one or more classification categories. In an example discussed below, classifier module 107 classifies or filters feedback texts based on privacy as the classification category. Classifier module 107 may also classify based on other classification categories such as security, accessibility, etc. Classifier module 107 may classify feedback texts into feedback texts of a specific category, such as privacy, and feedback texts that are not related to that category, which are categorized as “not privacy”.

Classified storage 105 may store the classified feedback texts of a category. The classified storage 105 is shown in FIG. 1 as being separate from feedback text storage 103, but the classified feedback texts may be tagged and stored along with unclassified feedback texts in feedback text storage 103.

Issue generation module 111 may analyze the categorized feedback texts and determine issues associated with the feedback texts. Issue generation module 111 may cluster feedback texts into issue clusters and then generate issue labels for the different issue clusters. A set of feedback text issues may include one or more issues associated with each feedback text. The set of feedback text issues may include one or more issues associated with each feedback text from feedback texts.

Issue generation module 111 may use a machine learning model such as a natural language processing (NLP) model (e.g., a transformer model, a recurrent neural network (RNN) model, etc.). For example, issue generation module 111 may use a T5 model, such as a T5-11B model.

Issue generation module 111 may improve glanceability by assigning meaningful, fine-grained issues to each review. Issue generation module 111 need not be restricted to predetermined topics. Instead, Issue generation module 111 may take an abstractive labeling approach, generating issue tags that distill long informal reviews into simple, easy-to-grasp issues (e.g., “Unwanted Password Sharing” or “Personal Address Deletion”). The issues may be dynamically generated, covering both commonly occurring issues as well as newly emerging ones. Theme title generator module 112 may receive the issue labels and construct theme labels for the feedback texts. For example, theme title generation module 112 may use the most frequent issues in a theme cluster to generate a theme title automatically via a summarization model.

Theme title generation module 112 may use a machine learning model such as a natural language processing (NLP) model (e.g., a transformer model, a recurrent neural network (RNN) model, etc.) For example, theme title generation module 112 may use a T5 model, such as a T5-11B model.

Theme title generation module 112 may take the issues and group them in clusters representing high-level themes. Each cluster may contain a set of related fine-grained issues. Theme title generation module 112 may include a generative model that assigns a concise title for each theme (e.g., “Sharing Concerns” or “Data Deletion”). This eliminates the manual work required to interpret clusters. In an exemplary annotation study with 600 groups of issues, an exemplary computing device 102 produced titles that were judged to be of high quality in 92% of the cases where 5 out of 7 annotators agree (20% higher than the baseline).

Emotion classifier module 114 may classify feedback texts based on emotions. Emotion classifier module 114 may classify into one of a set of emotions (e.g., neutral, desire, joy, surprise, confusion, disgust, fear, sadness, anger, etc.). Emotion classifier module 114 may use these emotion classifications to provide feedback text examples that reflect a variety of emotions. Emotion classifier module 114 may use a machine learning model such as an NLP model (e.g., a transformer model, model, etc.) In one example, emotion classifier module 114 may use a T5 model, such as a T5-11B model.

Emotion classifier module 114 may facilitate navigating GUI 142 as a hierarchy. Emotion classifier module 114 may include a classifier that filters issues and themes based on a user satisfaction measure, such as emotions (e.g., joy, anger, annoyance, confusion, etc.). This way of navigating the hierarchy may provide new insights into the topics that reviewers discuss. GUI 142 may include the ability to filter displayed reviews by emotion.

Quality classifier module 116 may classify feedback texts based on quality. Quality classifier module 116 may use the quality classifications to provide feedback text examples of high quality.

Quality classifier module 116 may use a machine learning model such as an NLP model (e.g., a transformer model, model, etc.) For example, quality classifier module 116 may use a T5 model, such as a T5-11B model.

Quality classifier module 116 may allow ranking of representative quotes per issue; this may enable developers to understand an issue in more detail, and in the user's voice, without having to read numerous reviews.

Overall, the computing device 102 may enable developers to explore the feedback texts from a high-level perspective (themes), then drill down into more details (fine-grained issues and then high-quality example reviews annotated with emotions). In one example, the system was applied to a large dataset of 626,000,000 publicly visible reviews covering 1,300,000 applications (an order of magnitude larger than previous works). The classifiers extracted over 6 million privacy-related reviews from that set.

The computing device 102 may use two main types of tasks: text classification and text generation. Classification tasks may allow assigning one or more predefined tags to a given input, such as email spam classification or language detection. Generation tasks may output free-form text for a given input, such as abstractive document summarization or machine translation.

The input to computing device 102 may be a text dataset of user feedback texts. Classifier module 107, such as a privacy classifier, may retain relevant feedback texts, such as privacy feedback, and exclude the rest. Next, the feedback texts may be fed into issue generation module 111, which may produce a set of fine-grained issues from each text. Issue generation module 111 may use an abstractive model that acts like a summarizer instead of an extractive one that simply gets relevant words from the feedback. Issue generation module 111 may turn feedback such as “I don't understand why I should allow you to my cam or calls” to (multiple) issues: “Unnecessary Camera Access” and “Unnecessary Calls Access.”

Next, these issues may be aggregated across the whole corpus and grouped into themes based on semantic similarity. Each group of issues and the associated feedback texts may constitute a theme. The most frequent issues in the theme may be used to generate a theme title automatically via an abstractive theme summarization model. For example, a theme with the top issues “Cannot Access Activity Controls,” “Turn Off Activity History,” and “Turn on Activity History” may get the title “Activity Management.”

By generating this hierarchy of high-level themes and fine-grained issues, techniques of this disclosure may enable developers to navigate the feedback, such as privacy feedback, at multiple levels of abstraction. To enrich the navigation experience, computing device 102 may include emotion classifier module 114 with multiple emotion categories, thus providing a way for filtering issues and themes by the level of anger, joy, confusion, etc. The computing device 102 may attach a set of high-quality quotes to each fine-grained issue, allowing developers to dig deeper into representative feedback behind the issues of interest. By combining the issues, themes, emotions, top quotes, and feedback metadata (timestamp, star rating, etc.), the computing device 102 may unlock this user-to-developer channel, equipping developers with the material to perform a variety of trend analyses and to track their progress on a variety of metrics.

Trend analysis module 122 may be used for trend analysis of the feedback texts and produce displays at GUI 142 of display device 140. Trend analysis module 122 may break down the feedback texts based on issues, themes, emotions, quality, etc. Trend analysis module 122 may also show changes over time in the feedback texts with respect to issues, themes, emotions, quality, etc.

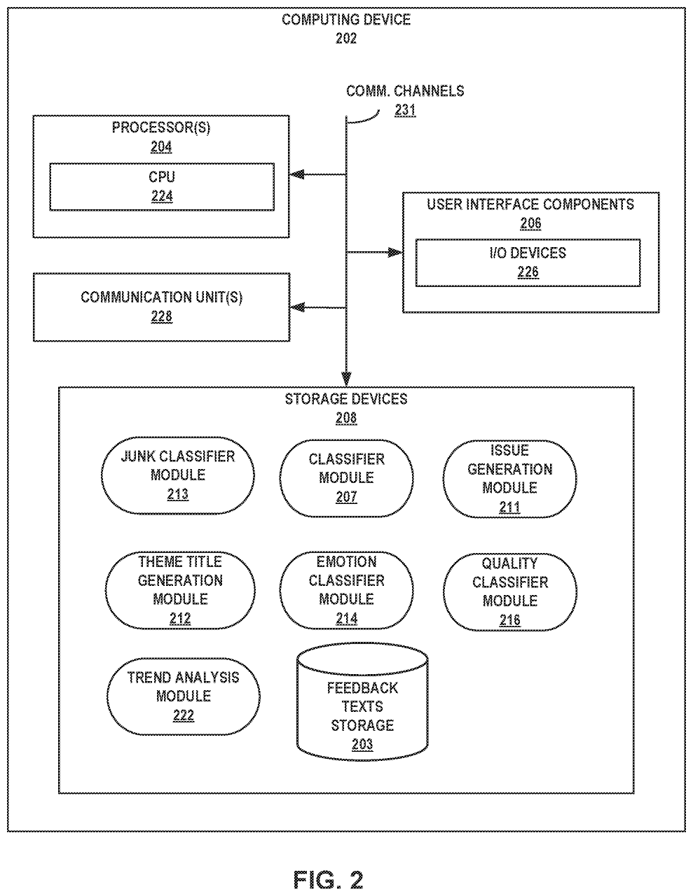

FIG. 2 is a block diagram illustrating an example computing device 202 for extracting, processing, and understanding reviews, in accordance with one or more aspects of the present disclosure. FIG. 2 illustrates one example computing system that may implement the techniques of this disclosure. Computing device 202 may include desktop computers, servers, mainframes, etc., and may be in communication with remote computing systems over one or more networks. Many other examples of computing device 202 may be used in other instances and may include a subset of the components included in exemplary computing device 202 or may include additional components not shown in FIG. 2.

As shown in the example of FIG. 2, computing device 202 includes processors 204, one or more input/output components, such as user interface components (UIC) 206, one or more communication units 228, and one or more storage devices 208. Storage devices 208 of computing device 202 may include junk classifier module 213, classifier module 207, issue generation module 211, theme title generation module 212, emotion classifier module 214, quality classifier module 216, trend analysis module 222, and feedback text storage 203. UIC 206 may include I/O (input/output) devices 226.

The one or more communication units 228 of computing device 202, for example, may communicate with external devices by transmitting and/or receiving data at computing device 202, such as to and from remote computer systems. For example, computing device 202 may receive, using communication units 228, feedback text information for analysis. Example communication units 228 include a network interface card (e.g., such as an Ethernet card), an optical transceiver, a radio frequency transceiver, or any other type of device that can send and/or receive information. Other examples of communication units 228 may be devices configured to transmit and receive Ultrawideband®, Bluetooth®, GPS, 3G, 4G, and Wi-Fi®, etc. that may be found in computing devices, such as mobile devices and the like.

As shown in the example of FIG. 2, communication channels 231 may interconnect each of the components as shown for inter-component communications (physically, communicatively, and/or operatively). In some examples, communication channels 231 may include a system bus, a network connection (e.g., to a wireless connection as described above), one or more inter-process communication data structures, or any other components for communicating data between hardware and/or software locally or remotely.

One or more storage devices 208 within computing device 202 may store information, such as data associated with applications and other data discussed herein, for processing during the operation of computing device 202. In some examples, one or more storage devices of storage devices 208 may be a volatile or temporary memory. Examples of volatile memories include random access memories (RAM), dynamic random-access memories (DRAM), static random-access memories (SRAM), and other forms of volatile memories known in the art. Storage devices 208, in some examples, may also include one or more computer-readable storage media. Storage devices 208 may be configured to store larger amounts of information for longer terms in non-volatile memory than volatile memory. Examples of non-volatile memories include magnetic hard disks, optical discs, floppy discs, flash memories, or forms of electrically programmable memories (EPROM) or electrically erasable and programmable (EEPROM) memories. Storage devices 208 may store program instructions and/or data associated with the modules 207-222 of FIG. 2.

One or more I/O devices 226 of computing device 202 may receive inputs and generate outputs. Examples of inputs are tactile, audio, kinetic, and optical input, to name only a few examples. Input devices of I/O devices 226, in one example, may include a touchscreen, a touchpad, a mouse, a keyboard, a voice responsive system, a video camera, buttons, a control pad, a microphone or any other type of device for detecting input from a human or machine. Output devices of I/O devices 226, may include, a sound card, a video graphics adapter card, a speaker, a display, or any other type of device for generating output to a human or machine.

Feedback text storage 203 is a storage repository for feedback text data. Feedback text storage 203 may include all or a portion of the feedback texts analyzed using the techniques of this disclosure. In some examples, feedback text storage 103 may operate, at least in part, as a cache for feedback text information retrieved from a remote computing system (e.g., using one or more communication units 228). In general, feedback text storage 203 may be configured as a database, flat file, table, or other data structure stored within storage device 208. In some examples, feedback text storage 203 is shared between various modules executing at computing device 202 (e.g., between one or more of modules 207-222 or other modules not shown in FIG. 2). In other examples, a different data repository is configured for a module executing at computing device 202 that requires a data repository. Each data repository may be configured and managed by different modules and may store data in a different manner.

Classifier module 207 may be a version of classifier module 107 of FIG. 1. Issue generation module 211 may be a version of issue generation module 111 of FIG. 1. Theme title generation module 212 may be a version of theme title generation module 112 of FIG. 1. Emotion classifier module 214 may be a version of emotion classifier module 114 of FIG. 1. Quality classifier module 216 may be a version of quality classifier module 116 of FIG. 1. Trend analysis module 222 may be a version of trend analysis module 122 of FIG. 1. Junk classifier module 213 may be a version of junk classifier module 113 of FIG. 1.

Classifier module 207, Issue generation module 211, theme title generation module 212, emotion classifier module 214, quality classifier module 216, trend analysis module 222 and junk classifier module 213 (hereinafter “modules 207-222”) may perform operations described herein using software, hardware, firmware, or a mixture of hardware, software, and firmware residing in and executing on computing device 202 or at one or more other remote computing devices (e.g., cloud-based application—not shown). Computing device 202 may execute one or more of modules 207-222, with one or more processors 204 or may execute any or part of one or more of modules 207-222 as or within a virtual machine executing on underlying hardware. One or more of modules 207-222 may be implemented in various ways, for example, as a downloadable or pre-installed application, remotely as a cloud application, or as part of the operating system of computing device 202. Other examples of computing device 202 that implement techniques of this disclosure may include additional components not shown in FIG. 2.

In the example of FIG. 2, one or more processors 204 may implement functionality and/or execute instructions within computing device 202. For example, one or more processors 204 may receive and execute instructions that provide the functionality of UIC 206, communication units 228, one or more storage devices 208 and an operating system to perform one or more operations as described herein. The one or more processors 204 include central processing unit (CPU) 224. Examples of CPU 224 include, but are not limited to, a digital signal processor (DSP), a general-purpose microprocessor, a tensor processing unit (TPU); a neural processing unit (NPU); a neural processing engine; a core of a CPU, VPU, GPU, TPU, NPU or another processing device, an application specific integrated circuit (ASIC), a field programmable logic array (FPGA), or other equivalent integrated or discrete logic circuitry, or other equivalent integrated or discrete logic circuitry.

One or more processors 204 may implement functionality and/or execute instructions within computing device 202. For example, one or more processors 204 may receive and execute instructions that provide the functionality of some or all of modules 207-222 to perform one or more operations and various functions described herein.

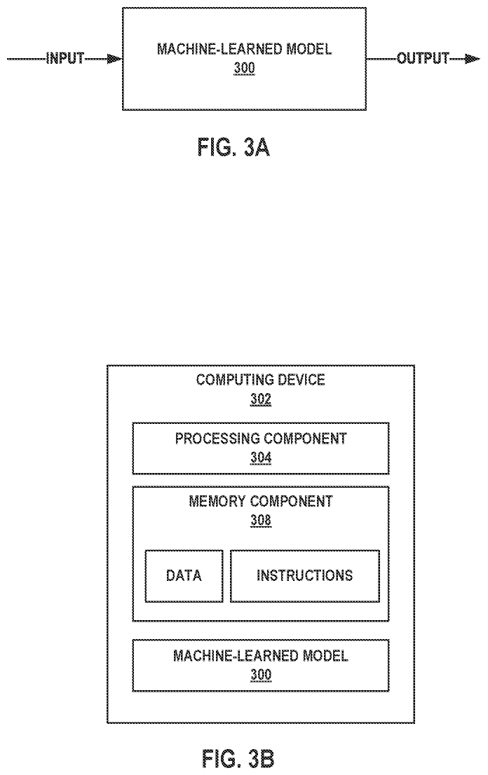

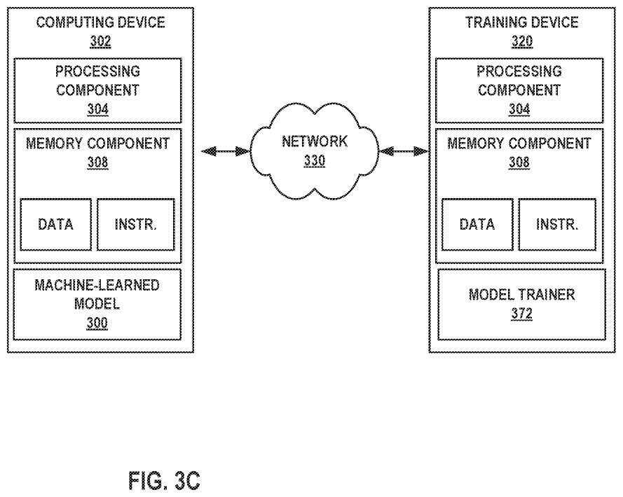

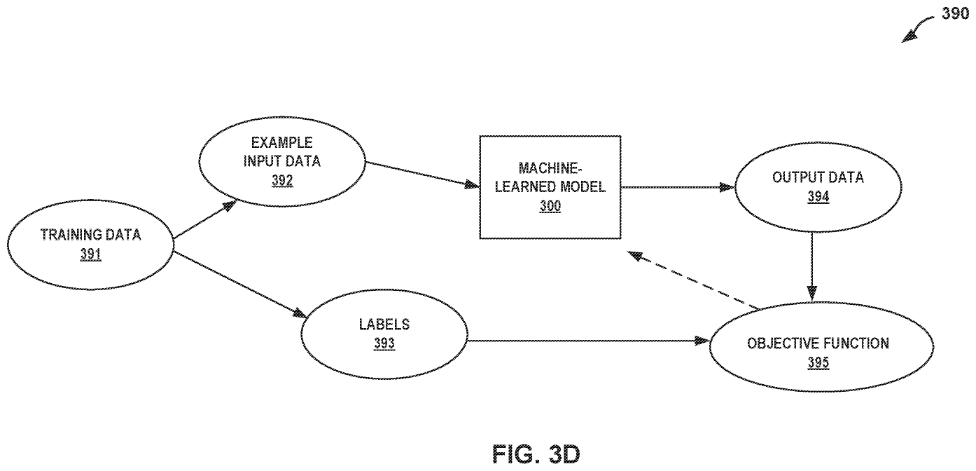

The modules 207-222 may be implemented using machine-learned models such as T5 models, (eg. a T5-11B model). Machine-learned models may be trained or fine-tuned for the specific tasks involved. Classifier module 207 may include a machine-learned model trained on a classifier task to classify feedback texts. Issue generation module 211 may include a machine-learned model trained to produce an issue text from the feedback texts. Theme title generation module 212 may include machine-learned models trained to group and generate a theme text from the issue texts. Emotion classifier module 214 may include a machine-learned model to generate text labeling an emotional quality of the feedback texts. Quality classifier module 216 may include a machine-learned model to generate text labeling the quality of feedback texts. Junk classifier module 213 may include a machine-learned model to determine whether a feedback text is junk. Details of such machine-learned models are described below with respect to FIGS. 3A-D, and 4-7.

FIGS. 3A-3D are conceptual diagrams illustrating aspects of an example machine-learned model according to example implementations of the present disclosure. FIGS. 3A-3D are described below in the context of modules 207-222 of FIG. 2. For example, in some instances, machine-learned model 300, as referenced below, may be an example of one used in modules 207-222 of FIG. 2 or the modules used with respect to FIGS. 1, 4, 5, and 6.

FIG. 3A depicts a conceptual diagram of an example machine-learned model according to example implementations of the present disclosure. As illustrated in FIG. 3A, in some implementations, machine-learned model 300 is trained to receive input data of one or more types and, in response, provide output data of one or more types. Thus, FIG. 3A illustrates machine-learned model 300 performing inference. For example, the input data received by machine-learned model 300 may be feedback texts, and the output data provided by machine-learned model 300 may be issue clusters and names, theme clusters and names, quality measures, emotion classifications, junk classifications, etc.

The input data may include one or more features that are associated with an instance or an example. In some implementations, one or more features associated with the instance or example may be organized into a feature vector. In some implementations, the output data may include one or more predictions. Thus, given features associated with a particular instance, machine-learned model 300 may output a prediction for such instances based on the features. Predictions may also be referred to as inferences.

Machine-learned model 300 may be or include one or more of various different types of machine-learned models. In particular, in some implementations, machine-learned model 300 may perform classification, summarization, name generation, regression, clustering, anomaly detection, recommendation generation, and/or other tasks.

In some implementations, machine-learned model 300 may perform various types of classification based on the input data. For example, machine-learned model 300 may perform binary classification or multiclass classification. In binary classification, the output data may include a classification of the input data into one of two different classes. In multiclass classification, the output data may include a classification of the input data into one (or more) of more than two classes. The classifications may be single-label or multi-label. Machine-learned model 300 may perform discrete categorical classification in which the input data is simply classified into one or more classes or categories.

In some implementations, machine-learned model 300 may perform various types of natural language processing (NLP) based on the input data. For example, machine-learned model 300 may summarize, translate, or organize the input data. The natural language processing (NLP) model may use recurrent neural networks (RNNs) and/or transformer models (self-attention models), such as GPT-3, BERT, and T5.

In some implementations, machine-learned model 300 may perform classification in which machine-learned model 300 provides, for each of one or more classes, a numerical value descriptive of a degree to which it is believed that the input data should be classified into the corresponding class. In some instances, the numerical values provided by machine-learned model 300 may be referred to as “confidence scores” that are indicative of a respective confidence associated with the classification of the input into the respective class. In some implementations, the confidence scores may be compared to one or more thresholds to render a discrete categorical prediction. In some implementations, only a certain number of classes (e.g., one) with the relatively largest confidence scores may be selected to render a discrete categorical prediction.

Machine-learned model 300 may output a probabilistic classification. For example, machine-learned model 300 may predict, given a sample input, a probability distribution over a set of classes. Thus, rather than outputting only the most likely class to which the sample input should belong, machine-learned model 300 may output, for each class, a probability that the sample input belongs to such class. In some implementations, the probability distribution over all possible classes may sum to one. In some implementations, a Softmax function or other type of function or layer may be used to squash a set of real values respectively associated with the possible classes to a set of real values in the range (0, 1) that sum to one.

In some examples, the probabilities provided by the probability distribution may be compared to one or more thresholds to render a discrete categorical prediction. In some implementations, only a certain number of classes (e.g., one) with the relatively largest predicted probability may be selected to render a discrete categorical prediction.

In cases in which machine-learned model 300 performs classification, machine-learned model 300 may be trained using supervised learning techniques. For example, machine-learned model 300 may be trained on a training dataset that includes training examples labeled as belonging (or not belonging) to one or more classes. Further details regarding supervised training techniques are provided below in the descriptions of FIGS. 3B through 3D.

In some implementations, machine-learned model 300 may perform regression to provide output data in the form of a continuous numeric value. The continuous numeric value may correspond to any number of different metrics or numeric representations, including, for example, currency values, scores, or other numeric representations. In examples, machine-learned model 300 may perform linear regression, polynomial regression, or nonlinear regression. In examples, machine-learned model 300 may perform simple regression or multiple regression. As described above, in some implementations, a Softmax function or other function or layer may be used to squash a set of real values respectively associated with two or more possible classes to a set of real values in the range (0, 1) that sum to one.

Machine-learned model 300 may perform various types of clustering. For example, machine-learned model 300 may identify one or more clusters to which the input data most likely corresponds. Machine-learned model 300 may identify one or more clusters within the input data. That is, in instances in which the input data includes multiple objects, documents, or other entities, machine-learned model 300 may sort the multiple entities included in the input data into a number of clusters. In some implementations in which machine-learned model 300 performs clustering, machine-learned model 300 may be trained using unsupervised learning techniques.

Machine-learned model 300 may, in some cases, act as an agent within an environment. For example, machine-learned model 300 may be trained using reinforcement learning, which will be discussed in further detail below.

In some implementations, machine-learned model 300 may be a parametric model while, in other implementations, machine-learned model 300 may be a non-parametric model. In some implementations, machine-learned model 300 may be a linear model while, in other implementations, machine-learned model 300 may be a non-linear model.

As described above, machine-learned model 300 may be or include one or more of various different types of machine-learned models. Examples of such different types of machine-learned models are provided below for illustration. One or more of the example models described below may be used (e.g., combined) to provide the output data in response to the input data. Additional models beyond the example models provided below may be used as well.

In some implementations, machine-learned model 300 may be or include one or more classifier models such as, for example, linear classification models; quadratic classification models; etc. Machine-learned model 300 may be or include one or more regression models such as, for example, simple linear regression models; multiple linear regression models; logistic regression models; stepwise regression models; multivariate adaptive regression splines; locally estimated scatterplot smoothing models; etc.

In some implementations, machine-learned model 300 may be or include one or more artificial neural networks (also referred to simply as neural networks). A neural network may include a group of connected nodes, which also may be referred to as neurons or perceptrons. A neural network may be organized into one or more layers. Neural networks that include multiple layers may be referred to as “deep” networks. A deep network may include an input layer, an output layer, and one or more hidden layers positioned between the input layer and the output layer. The nodes of the neural network may be connected or non-fully connected.

Machine-learned model 300 may be or include one or more feed-forward neural networks. In feed forward-networks, the connections between nodes do not form a cycle. For example, each connection may connect a node from an earlier layer to a node from a later layer.

In some instances, machine-learned model 300 may be or include one or more recurrent neural networks. In some instances, at least some of the nodes of a recurrent neural network may form a cycle. Recurrent neural networks may be especially useful for processing input data that is sequential in nature. In particular, in some instances, a recurrent neural network may pass or retain information from a previous portion of the input data sequence to a subsequent portion of the input data sequence through the use of recurrent or directed cyclical node connections.

In some examples, sequential input data may include time-series data (e.g., sensor data versus time or imagery captured at different times). For example, a recurrent neural network may analyze sensor data versus time to detect or predict a swipe direction, to perform handwriting recognition, etc. Sequential input data may include words in a sentence (e.g., for natural language processing, speech detection or processing, etc.); notes in a musical composition; sequential actions taken by a user (e.g., to detect or predict sequential application usage); sequential object states; etc.

Example recurrent neural networks include long short-term (LSTM) recurrent neural networks; gated recurrent units; bi-direction recurrent neural networks; continuous-time recurrent neural networks; neural history compressors; echo state networks; Elman networks; Jordan networks; recursive neural networks; Hopfield networks; fully recurrent networks; sequence-to-sequence configurations; etc.

In some implementations, machine-learned model 300 may be or include one or more convolutional neural networks. In some instances, a convolutional neural network may include one or more convolutional layers that perform convolutions over input data using learned filters.

Filters may also be referred to as kernels. Convolutional neural networks may be especially useful for vision problems such as when the input data includes imagery such as still images or video. However, convolutional neural networks may also be applied for natural language processing.

In some examples, machine-learned model 300 may be or include one or more generative networks such as, for example, generative adversarial networks. Generative networks may be used to generate new data such as artificial feedback texts

Machine-learned model 300 may be or include an autoencoder. In some instances, the aim of an autoencoder is to learn a representation (e.g., a lower-dimensional encoding) for a set of data, typically for the purpose of dimensionality reduction. For example, in some instances, an autoencoder may seek to encode the input data and then provide output data that reconstructs the input data from the encoding. Recently, the autoencoder concept has become more widely used for learning generative models of data. In some instances, the autoencoder may include additional losses beyond reconstructing the input data.

Machine-learned model 300 may be or include one or more other forms of artificial neural networks such as, for example, deep Boltzmann machines; deep belief networks; stacked autoencoders; etc. Any of the neural networks described herein may be combined (e.g., stacked) to form more complex networks.

One or more neural networks may be used to provide an embedding based on the input data. For example, the embedding may be a representation of knowledge abstracted from the input data into one or more learned dimensions. In some instances, embeddings may be a useful source for identifying related entities. In some instances, embeddings may be extracted from the output of the network, while in other instances embeddings may be extracted from any hidden node or layer of the network (e.g., a close to final but not final layer of the network). Embeddings may be useful for performing auto-suggest next video, product suggestion, entity or object recognition, etc. In some instances, embeddings are useful inputs for downstream models. For example, embeddings may be useful to generalize input data (e.g., search queries) for a downstream model or processing system.

In some implementations, machine-learned model 300 may perform one or more dimensionality reduction techniques such as, for example, principal component analysis; kernel principal component analysis; graph-based kernel principal component analysis; principal component regression; partial least squares regression; Sammon mapping; multidimensional scaling; projection pursuit; linear discriminant analysis; mixture discriminant analysis; quadratic discriminant analysis; generalized discriminant analysis; flexible discriminant analysis; autoencoding; etc.

In some implementations, machine-learned model 300 may perform or be subjected to one or more reinforcement learning techniques such as Markov decision processes; dynamic programming; Q functions or Q-learning; value function approaches; deep Q-networks; differentiable neural computers; asynchronous advantage actor-critics; deterministic policy gradient; etc.

In some implementations, machine-learned model 300 may be an autoregressive model. In some instances, an autoregressive model may specify that the output data depends linearly on its own previous values and on a stochastic term. In some instances, an autoregressive model may take the form of a stochastic difference equation. One example of an autoregressive model is WaveNet, which is a generative model for raw audio.

In some implementations, machine-learned model 300 may include or form part of a multiple model ensemble. As one example, bootstrap aggregating may be performed, which may also be referred to as “bagging.” In bootstrap aggregating, a training dataset is split into a number of subsets (e.g., through random sampling with replacement) and a plurality of models are respectively trained on the number of subsets. At inference time, respective outputs of the plurality of models may be combined (e.g., through averaging, voting, or other techniques) and used as the output of the ensemble.

One example ensemble is a random forest, which may also be referred to as a random decision forest. Random forests are an ensemble learning method for classification, regression, and other tasks. Random forests are generated by producing a plurality of decision trees at training time. In some instances, at inference time, the class that is the mode of the classes (classification) or the mean prediction (regression) of the individual trees may be used as the output of the forest. Random decision forests may correct for decision trees' tendency to overfit their training set.

Another example ensemble technique is stacking, which can, in some instances, be referred to as stacked generalization. Stacking includes training a combiner model to blend or otherwise combine the predictions of several other machine-learned models. Thus, a plurality of machine-learned models (e.g., of the same or different type) may be trained based on training data. In addition, a combiner model may be trained to take the predictions from the other machine-learned models as inputs and, in response, produce a final inference or prediction. In some instances, a single-layer logistic regression model may be used as the combiner model.

Another example of ensemble techniques is boosting. Boosting may include incrementally building an ensemble by iteratively training weak models and then adding to a final strong model. For example, in some instances, each new model may be trained to emphasize the training examples that previous models misinterpreted (e.g., misclassified). For example, a weight associated with each of such misinterpreted examples may be increased. One common implementation of boosting is AdaBoost, which may also be referred to as Adaptive Boosting. Other example boosting techniques include LPBoost; TotalBoost; BrownBoost; xgboost; MadaBoost, LogitBoost, gradient boosting; etc. Furthermore, any of the models described above (e.g., regression models and artificial neural networks) may be combined to form an ensemble. As an example, an ensemble may include a top-level machine-learned model or a heuristic function to combine and/or weight the outputs of the models that form the ensemble.

In some implementations, multiple machine-learned models (e.g., that form an ensemble may be linked and trained jointly (e.g., through backpropagation of errors sequentially through the model ensemble). However, in some implementations, only a subset (e.g., one) of the jointly trained models is used for inference.

In some implementations, machine-learned model 300 may be used to preprocess the input data for subsequent input into another model. For example, machine-learned model 300 may perform dimensionality reduction techniques and embeddings (e.g., matrix factorization, principal components analysis, singular value decomposition, word2vec/GLOVE, and/or related approaches); clustering; and even classification and regression for downstream consumption. Many of these techniques have been discussed above and will be further discussed below.

As discussed above, machine-learned model 300 may be trained or otherwise configured to receive the input data and, in response, provide the output data. The input data may include different types, forms, or variations of input data. As examples, in various implementations, the input data may include features that describe the content (or portion of content) initially selected by the user, e.g., content of user-selected document or image, links pointing to the user selection, links within the user selection relating to other files available on device or cloud, metadata of user selection, etc.

Additionally, with user permission, the input data includes the context of user usage, either obtained from the app itself or from other sources. Examples of usage context include breadth of share (sharing publicly, or with a large group, or privately, or a specific person), context of share, etc. When permitted by the user, additional input data may include the state of the device, e.g., the location of the device, the apps running on the device, etc.

In some implementations, machine-learned model 300 may receive and use the input data in its raw form. In some implementations, the raw input data may be preprocessed. Thus, in addition or alternatively to the raw input data, machine-learned model 300 may receive and use the preprocessed input data.

In some implementations, preprocessing the input data may include extracting one or more additional features from the raw input data. For example, feature extraction techniques may be applied to the input data to generate one or more new, additional features. Example feature extraction techniques include edge detection; corner detection; blob detection; ridge detection; scale-invariant feature transform; motion detection; optical flow; Hough transform; etc.

In some implementations, the extracted features may include or be derived from transformations of the input data into other domains and/or dimensions. As an example, the extracted features may include or be derived from transformations of the input data into the frequency domain. For example, wavelet transformations and/or fast Fourier transforms may be performed on the input data to generate additional features.

In some implementations, the extracted features may include statistics calculated from the input data or certain portions or dimensions of the input data. Example statistics include the mode, mean, maximum, minimum, or other metrics of the input data or portions thereof.

In some implementations, as described above, the input data may be sequential in nature. In some instances, the sequential input data may be generated by sampling or otherwise segmenting a stream of input data. As one example, frames may be extracted from a video. In some implementations, sequential data may be made non-sequential through summarization.

As another example of preprocessing techniques, portions of the input data may be imputed. For example, additional synthetic input data may be generated through interpolation and/or extrapolation.

As another example of preprocessing techniques, some or all of the input data may be scaled, standardized, normalized, generalized, and/or regularized. Example regularization techniques include ridge regression; least absolute shrinkage and selection operator (LASSO); elastic net; least-angle regression; cross-validation; L1 regularization; L2 regularization; etc. For example, some or all of the input data may be normalized by subtracting the mean across a given dimension's feature values from each feature value and then dividing by the standard deviation or another metric.

As another example of preprocessing techniques, some or all or the input data may be quantized or discretized. In some cases, qualitative features or variables included in the input data may be converted to quantitative features or variables. For example, one hot encoding may be performed.

In some examples, dimensionality reduction techniques may be applied to the input data prior to input into machine-learned model 300. Several examples of dimensionality reduction techniques are provided above, including, for example, principal component analysis; kernel principal component analysis; graph-based kernel principal component analysis; principal component regression; partial least squares regression; Sammon mapping; multidimensional scaling; projection pursuit; linear discriminant analysis; mixture discriminant analysis; quadratic discriminant analysis; generalized discriminant analysis; flexible discriminant analysis; autoencoding; etc.

In some implementations, during training, the input data may be intentionally deformed in any number of ways to increase model robustness, generalization, or other qualities. Example techniques to deform the input data include adding noise; changing color, shade, or hue; magnification; segmentation; amplification; etc.

In response to receipt of the input data, machine-learned model 300 may provide the output data. The output data may include different types, forms, or variations of output data. As examples, in various implementations, the output data may include content, either stored locally on the user device or in the cloud, that is relevantly shareable along with the initial content selection.

As discussed above, in some implementations, the output data may include various types of classification data (e.g., binary classification, multiclass classification, single label, multi-label, discrete classification, regressive classification, probabilistic classification, etc.) or may include various types of regressive data (e.g., linear regression, polynomial regression, nonlinear regression, simple regression, multiple regression, etc.). In other instances, the output data may include clustering data, anomaly detection data, recommendation data, or any of the other forms of output data discussed above.

In some implementations, the output data may influence downstream processes or decision-making. As one example, in some implementations, the output data may be interpreted and/or acted upon by a rules-based regulator.

The present disclosure provides systems and methods that include or otherwise leverage one or more machine-learned models to classify feedback texts, determine a number of issues from the classified feedback texts, and generate themes from the issues Any of the different types or forms of input data described above may be combined with any of the different types or forms of machine-learned models described above to provide any of the different types or forms of output data described above.

The systems and methods of the present disclosure may be implemented by or otherwise executed on one or more computing devices. Example computing devices include user computing devices (e.g., laptops, desktops, and mobile computing devices such as tablets, smartphones, wearable computing devices, etc.); embedded computing devices (e.g., devices embedded within a vehicle, camera, image sensor, industrial machine, satellite, gaming console or controller, or home appliance such as a refrigerator, thermostat, energy meter, home energy manager, smart home assistant, etc.); other computing devices; or combinations thereof.

FIG. 3B illustrates a conceptual diagram of computing device 302, which is an example of computing device 102 of FIG. 1 and computing device 202 FIG. 2. Computing device 302 includes a processing component 304, memory component 308, and machine-learned model 300. Computing device 302 may store and implement machine-learned model 300 locally (i.e., on-device). Thus, machine-learned model 300 may be stored at and/or implemented locally by an embedded device or a user computing device such as a mobile device. Output data obtained through local implementation of machine-learned model 300 at the embedded device or the user computing device may be used to improve the performance of the embedded device or the user computing device (e.g., an application implemented by the embedded device or the user computing device).

FIG. 3C illustrates a conceptual diagram of an example computing device in communication with an example training computing system that includes a model trainer. FIG. 3C includes computing device 302 communicating with training device 320 over network 330. Computing device 302 is an example of computing device 202 of FIG. 1. machine-learned model 300 described herein may be trained at a training computing system, such as training device 320, and then provided for storage and/or implementation at one or more computing devices, such as computing device 302. For example, model trainer 372 executes locally at training device 320. In some examples, training device 320, including model trainer 372, may be included in or separate from a computing device 302 or any other computing device that implements machine-learned model 300.

Computing device 302 and/or training device 320 may be implemented as a cloud-based system. Computing device 302 may implement functionality for application designers. The models at computing device 302 may be updated using new feedback texts periodically such as once a month.

Computing device 302 that implements machine-learned model 300 or other aspects of the present disclosure and training device 320 that trains machine-learned model 300 may include a number of hardware components that enable the performance of the techniques described herein. For example, computing device 302 may include one or more memory devices that store some or all of machine-learned model 300. For example, machine-learned model 300 may be a structured numerical representation that is stored in memory. The one or more memory devices may also include instructions for implementing machine-learned model 300 or performing other operations. Example memory devices include RAM, ROM, EEPROM, EPROM, flash memory devices, magnetic disks, etc., and combinations thereof.

Computing device 302 may also include one or more processing devices that implement some or all of machine-learned model 300 and/or perform other related operations. Example processing devices include one or more of: a central processing unit (CPU); a visual processing unit (VPU); a graphics processing unit (GPU); a tensor processing unit (TPU); a neural processing unit (NPU); a neural processing engine; a core of a CPU, VPU, GPU, TPU, NPU or another processing device; an application specific integrated circuit (ASIC); a field programmable gate array (FPGA); a co-processor; a controller; or combinations of the processing devices described above. Processing devices may be embedded within other hardware components such as, for example, an image sensor, accelerometer, etc.

Training device 320 may perform graph processing techniques or other machine learning techniques using one or more machine learning platforms, frameworks, and/or libraries, such as, for example, TensorFlow, Caffe/Caffe2, Theano, Torch/PyTorch, MXnet, CNTK, etc. In some implementations, machine-learned model 300 may be trained in an offline fashion or an online fashion. In offline training (also known as batch learning), machine-learned model 300 is trained on the entirety of a static set of training data. In online learning, machine-learned model 300 is continuously trained (or re-trained) as new training data becomes available (e.g., while the model is used to perform inference).

Model trainer 372 may perform centralized training of machine-learned model 300 (e.g., based on a centrally stored dataset). In other implementations, decentralized training techniques such as distributed training, federated learning, or the like may be used to train, update, or personalize machine-learned model 300.

Machine-learned model 300 described herein may be trained according to one or more of various different training types or techniques. For example, in some implementations, machine-learned model 300 may be trained by model trainer 372 using supervised learning, in which machine-learned model 300 is trained on a training dataset that includes instances or examples that have labels. The labels may be manually applied by experts, generated through crowdsourcing, or provided by other techniques (e.g., by physics-based or complex mathematical models). In some implementations, if the user has provided consent, the training examples may be provided by the user computing device. In some implementations, this process may be referred to as personalizing the model.

Once training device 320 has finished training machine-learned model 300, machine-learned model 300 may be installed onto computing device 302. For example, training device 320 may transfer machine-learned model 300 to computing device 302 via network 330, or machine-learned model 300 may be installed in computing device 302 during manufacturing of computing device 302. In some examples, once machine-learned model 300 has been trained at training device 320, training device 320 may perform post-training weight quantization, such as by using TensorFlow Lite libraries, to compress model weights, such as by compressing model weights into 8-bit integers, to enable computing device 302 to perform more efficient on-device inference using machine-learned model 300.

According to the techniques of this disclosure, training device 320 may be used to train machine learned model 300 on a broad corpus of feedback texts from multiple applications. As described below, training device 320 may train multiple machine-learned-models, including machine-learned model 300, which may be used by computing device 302. Computing device 302 may use machine learned model 300 to process feedback texts for a specific application in an inference mode. The inference mode, at computing device 302 may be rerun periodically such as once a month. This may depend on the influx of new feedback texts for an application. Training device 320 may fine-tune machine learned model 300 for specific applications. Computing device 302 may provide a cloud-based service that allows application designers to review feedback texts using a hierarchy of high-level issue themes and fine-grained issues within each theme, alongside representative reviews for each issue

FIG. 3D illustrates a conceptual diagram of training process 390 which is an example training process in which machine-learned model 300 is trained on training data 391 that includes example input data 392 that has labels 393. Training process 390 is one example training process; other training processes may be used as well.

Training data 391 used by training process 390 may include, upon user permission for use of such data for training, historical values of memory metrics of computing devices over time. In some examples, training data 391 may include data generated by performing stress tests by executing a plurality of applications over a variety of computing devices. The different computing devices may include computing devices made by different manufacturers, different models of computing devices made by the same manufacturer, computing devices including different processors, computing devices having different amounts of memory (e.g., RAM) that may be allocated by processes executing at the computing devices, computing devices running different versions of operating systems, computing devices that execute different combinations of applications and/or processes, computing devices having different versions of firmware, and the like.

Stress tests may be performed on each of the computing devices by executing a plurality of applications and/or processes on each of the computing devices that may continue to allocate memory until the computing device terminates an application and/or process, such as due to the computing device being out of memory or being low on memory. As the applications and/or processes execute on the computing devices during the stress tests, the applications and/or processes may allocate different types of memory (e.g., native heap memory and/or graphics memory), values of memory metrics of the computing devices as the applications and/or processes execute may be monitored and collected. Similarly, when an application and/or process is terminated by, for example, a low memory termination module at a computing device, the values of memory metrics when the application and/or processes are terminated may also be collected. Such stress tests may be run thousands of times (e.g., over 2000 times).

The training data may therefore include values of memory metrics collected by the computing devices while applications and/or processes execute during periods of time where no application or process was terminated due to a low memory or an out-of-memory condition. The training data may also include values of memory metrics collected by the computing devices while applications and/or processes execute at points in time when an application and/or process was terminated due to a low memory or an out-of-memory condition. Examples of the memory metrics may include any combination of the memory metrics listed above. In some implementations, training data 391 may include examples of input data 392 that have been assigned labels 393 that correspond to output data 394.

In some implementations, machine-learned model 300 may be trained by optimizing an objective function, such as objective function 395. For example, in some implementations, objective function 395 may be or include a loss function that compares (e.g., determines a difference between) output data generated by the model from the training data and labels (e.g., ground-truth labels) associated with the training data. For example, the loss function may evaluate a sum or mean of squared differences between the output data and the labels. In some examples, objective function 395 may be or include a cost function that describes a cost of a certain outcome or output data. Other examples of objective function 395 may include margin-based techniques such as, for example, triplet loss or maximum-margin training.

One or more of various optimization techniques may be performed to optimize objective function 395. For example, the optimization technique(s) may minimize or maximize objective function 395. Example optimization techniques include Hessian-based techniques and gradient-based techniques, such as, for example, coordinate descent; gradient descent (e.g., stochastic gradient descent); subgradient methods; etc. Other optimization techniques include black-box optimization techniques and heuristics.

In some implementations, backward propagation of errors may be used in conjunction with an optimization technique (e.g., gradient-based techniques) to train machine-learned model 300 (e.g., when the machine-learned model is a multi-layer model such as an artificial neural network). For example, an iterative cycle of propagation and model parameter (e.g., weights) update may be performed to train machine-learned model 300. Example backpropagation techniques include truncated backpropagation through time, Levenberg-Marquardt backpropagation, etc.

In some implementations, machine-learned model 300 described herein may be trained using unsupervised learning techniques. Unsupervised learning may include inferring a function to describe hidden structure from unlabeled data. For example, a classification or categorization may not be included in the data. Unsupervised learning techniques may be used to produce machine-learned models capable of performing clustering, anomaly detection, learning latent variable models, or other tasks.

Machine-learned model 300 may be trained using semi-supervised techniques which combine aspects of supervised learning and unsupervised learning. Machine-learned model 300 may be trained or otherwise generated through evolutionary techniques or genetic algorithms. In some implementations, machine-learned model 300 described herein may be trained using reinforcement learning. In reinforcement learning, an agent (e.g., model) may take actions in an environment and learn to maximize rewards and/or minimize penalties that result from such actions. Reinforcement learning may differ from the supervised learning problem in that correct input/output pairs are not presented, nor sub-optimal actions explicitly corrected.

In some implementations, one or more generalization techniques may be performed during training to improve the generalization of machine-learned model 300. Generalization techniques may help reduce overfitting of machine-learned model 300 to the training data. Example generalization techniques include dropout techniques; weight decay techniques; batch normalization; early stopping; subset selection; stepwise selection; label smoothing; etc.

In some implementations, machine-learned model 300 described herein may include or otherwise be impacted by a number of hyperparameters, such as, for example, learning rate, number of layers, number of nodes in each layer, number of leaves in a tree, number of clusters; etc. Hyperparameters may affect model performance. Hyperparameters may be hand selected or may be automatically selected through the application of techniques such as, for example, grid search; black-box optimization techniques (e.g., Bayesian optimization, random search, etc.); gradient-based optimization; etc. Example techniques and/or tools for performing automatic hyperparameter optimization include Hyperopt; Auto-WEKA; Spearmint; Metric Optimization Engine (MOE); etc.

In some implementations, various techniques may be used to optimize and/or adapt the learning rate when the model is trained. Example techniques and/or tools for performing learning rate optimization or adaptation include Adagrad; Adaptive Moment Estimation (ADAM); Adadelta; RMSprop; etc.

In some implementations, transfer learning techniques may be used to provide an initial model from which to begin training of machine-learned model 300 described herein.

In some implementations, machine-learned model 300 described herein may be included in different portions of computer-readable code on a computing device. In one example, machine-learned model 300 may be included in a particular application or program and used (e.g., exclusively) by such particular application or program. Thus, in one example, a computing device may include a number of applications, and one or more of such applications may contain its own respective machine learning library and machine-learned model(s).

In another example, machine-learned model 300 described herein may be included in an operating system of a computing device (e.g., in a central intelligence layer of an operating system) and may be called or otherwise used by one or more applications that interact with the operating system. In some implementations, each application may communicate with the central intelligence layer (and model(s) stored therein) using an application programming interface (API) (e.g., a common, public API across all applications).

In some implementations, the central intelligence layer may communicate with a central device data layer. The central device data layer may be a centralized repository of data for the computing device. The central device data layer may communicate with a number of other components of the computing device, such as, for example, one or more sensors, a context manager, a device state component, and/or additional components. In some implementations, the central device data layer may communicate with each device component using an API (e.g., a private API).

The technology discussed herein refers to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination.

Databases and applications may be implemented on a single system or distributed across multiple systems. Distributed components may operate sequentially or in parallel.

In addition, the machine learning techniques described herein are readily interchangeable and combinable. Although certain example techniques have been described, many others exist and may be used in conjunction with aspects of the present disclosure.

In some implementations, transfer learning (TL) may be used. Transfer learning involves reusing a model and its model parameters obtained while solving one problem and applying it to a different but related problem. Models trained on very large data sets may be retrained or fine-tuned on additional data. Often, all model designs and their parameters on a source model are copied except output layer(s). The output layers(s) are often called the head, and other layers are often called the base. The source parameters may be considered to contain the knowledge learned from the source dataset and this knowledge may also be applicable to a target dataset. Fine-tuning may include updating the head parameters with the body parameters being fixed or updated in a later step. Pretrained models, such as T5 models, are often available from Hugging Face or off of GitHub.

A brief overview of example machine-learned models and associated techniques has been provided by the present disclosure. For additional details, readers should review the following references: Machine Learning A Probabilistic Perspective (Murphy); Rules of Machine Learning: Best Practices for ML Engineering (Zinkevich); Deep Learning (Goodfellow); Reinforcement Learning: An Introduction (Sutton); and Artificial Intelligence: A Modern Approach (Norvig).

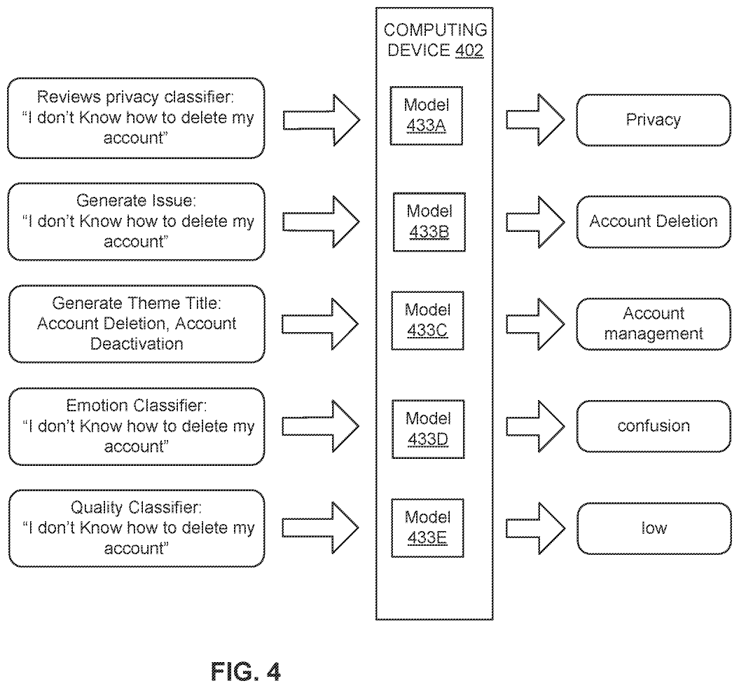

FIG. 4 is a conceptual diagram illustrating an exemplary modeling approach. In this example, the computing device 402 includes a number of models 433A-E that may be machine learned models, such as T5 text to text models. T5-based models may be used in the various generation and classification tasks with optimizations to tailor the models to the domain at hand. The models correspond to modules used in FIG. 1. Model 433A corresponds to classifier module 107 of FIG. 1 adapted to classify feedback texts based on whether they include privacy issues or not. Model 433B corresponds to issue generation module 111 of FIG. 1. Model 433C corresponds to theme title generation module 112 of FIG. 1. Model 433D corresponds to emotion classifier module 114 of FIG. 1. Model 433E corresponds to quality classifier module 116 of FIG. 1.

T5 models are typically used for transfer learning where a model is first pre-trained on extensive data-rich tasks before being fine-tuned on a downstream task. T5 models are typically pre-trained on a multi-task mixture of unsupervised and supervised tasks. Pretrained T5 models are available from Hugging Face or off of GitHub. Computing device 402 may then finetune the T5 models using training data for the relevant tasks.

Computing device 402 may treat each task as a text-to-text task and may separately fine-tune a T5 model for each respective task. T5 models are highly amenable to usage in multi-task scenarios when each task, regardless of its original formulation, is cast as text-to-text tasks.

Computing device 402 may tokenize (i.e., separate into tokens) input text using a tokenizer, such as the T5 SentencePiece tokenizer, that breaks each review into a sequence of sub-words, thus minimizing the effect of out-of-vocabulary words.

Computing device 402 may fine-tune T5 models on the training data using objective functions such as a maximum likelihood training objective. Computing device 402 may fine-tune the T5 models 433A-E using teacher forcing. Since T5 models are text-to-text models, teacher forcing uses input text sequences and target text sequences.

In an inference mode (i.e., when the models are run on new data), computing device 402 may decode text one token at a time. In a “greedy” decoding setup, computing device 402 may select the token with the maximum log-likelihood (referred to as logit) at each step. For classification tasks, computing device 402 may compute scores of the different possibilities. Computing device 402 may compute these scores by feeding the input text to the model encoder and each of the target classes' text to the model decoder. Given the logits of these classes, computing device 402 may apply a Softmax function to obtain a set of normalized scores that sum up to 1.

In the example of FIG. 4, model 433A corresponding to classifier module 107 of FIG. 1 inputs a feedback text of “I don't know how to delete my account” and classifies it as related to privacy. Model 433B corresponding to issue generation module 111 of FIG. 1 generates an issue for the feedback text of “I don't know how to delete my account” as being “account deletion”. Model 433C corresponding to theme title generation module 112 of FIG. 1. generates a theme using input issue titles such as “account deletion” and “account deactivation” to produce a theme title of “account management.” Model 433D corresponding to emotion classifier module 114 of FIG. 1 classifies the feedback text of “I don't know how to delete my account” as related to “confusion.” Model 433E corresponding to quality classifier module 116 of FIG. 1 classifies the feedback text of “I don't know how to delete my account” as “low.”

FIG. 5 is a conceptual diagram illustrating various steps for building a privacy classifier module 507. Privacy feedback classifier module 507 may distinguish reviews related to privacy from those which are not. As noted above, this disclosure mainly discusses a privacy classifier, but the techniques of this disclosure may be applied to other classifications, including security, accessibility bugs, performance, crashes, etc.

In the example of FIG. 5, NLI model 531 and other steps are used as part of the training of privacy classifier module 507. Privacy classifier module 507 is a version of classifier module 107 of FIG. 1 or classifier module 207 of FIG. 2 that is trained to classify feedback texts as be related or unrelated to privacy. Once privacy classifier module 507 is trained it may be exported and used in the systems of FIGS. 1 and 2 as classifier module 107 or classifier module 207.

In the example of FIG. 5, the feedback texts are likely to be unbalanced, so merely sampling these reviews is likely to miss privacy concepts. To generate a high diversity of the various privacy concepts, two of the most common and complementary taxonomies developed for privacy may be used: the taxonomy of privacy violations and the taxonomy of privacy-enhancing technologies.

To identify sample reviews covering different topics, a Natural Language Inference (NLI) model 531 may decide whether a natural language hypothesis may reasonably be inferred from a given premise (feedback text). NLI model 531 may determine whether a hypothesis is true (i.e., entailment), false (i.e., contradiction), or undetermined (i.e., neutral) given a premise (feedback text). For example, given a premise of “This app does not offer any visibility controls to hide your information.”, a hypothesis that says “app data is publicly accessible” would receive an entailment label. A hypothesis that says “app data is kept private” would receive a contradiction label. A hypothesis that says “app has a good interface” would receive a neutral label.

The premises in the example may be the feedback texts. The hypotheses may be manually constructed based on the privacy concepts selected earlier. For each privacy concept, there may be one or more hypotheses. For example, for the “blackmailing” concept, the hypothesis “A data blackmailing issue is discussed” may be used. Additional hypotheses cover generic mentions of privacy issues or positive privacy features. NLI model 531 may be a model trained on MultiNLI, which is a multi-genre dataset of 433K sentence pairs covering a variety of domains. This helps the handling of the general breadth of topics raised in feedback texts. NLI model 531 may use the Vanilla T5-11B model checkpoint and may be fine-tuned on a MultiNLI dataset. In one example, NLI model 531 is run on a dataset of 9,000,000 reviews, randomly sampled from a full dataset of 626,000,000 reviews. With 35 hypotheses, this amounts to a total of 35×9,000,000=315,000,000 inference operations. These 9,000,000 reviews and the entailment probabilities assigned per hypothesis may be considered as the NLI-Annotated Corpus. One major advantage of this method is that it eliminates the reliance on keywords. The premises corresponding to the hypotheses may have a high linguistic variability. For instance, both of the following reviews receive an entailment label for the hypothesis “Personal data disclosure is discussed.”:
“this game will NOT open unless you agree to them sharing your information to advertisers” (P(entailment)=0.89)
“and doesn't ask for access to unneeded personal data permissions. Well done developers 5 Stars” (P(entailment)=0.75)

In the above example, the first review has no words in common with the hypothesis. Neither review mentions disclosure, and one of them explains a problem while the other has a positive sentiment. At this stage, the hypotheses are not meant to completely cover the underlying concepts. However, the hypotheses are meant to produce enough candidate training data so that, when annotated, the entire model may generalize to such concepts.

The NLI-Annotated Corpus may be used to sample diverse data for manual labeling. Given the 9,000,000 reviews, let NE (i, t) be the number of hypotheses (out of the 36 example hypotheses) receiving an entailment score above a threshold t for review i. In one example, the following heuristics are used:
Review i is not-privacy related if NE (i, 0.4)=0.
Review i is privacy related if NE (i, 0.8)>=1 or
NE (i, 0.7)>=3 or NE (i, 0.6)>=5 or NE (i, 0.5)>=7.

The more hypotheses a review satisfies, the more likely it is to be within the privacy domain. The rest of the reviews that satisfy neither of these heuristics are considered undetermined and are not used further. This is to leave a safe margin between these heuristics.

From these reviews annotated by the heuristics, in one example, 3,254 reviews were randomly sampled so that there is nearly equal representation across:
(1) privacy vs. not-privacy labels,
(2) 4 different review word-length buckets, and
(3) app categories.

These sampled reviews may be manually annotated to create a high-quality privacy training dataset. In order to mitigate the effect of individual perceptions of what constitutes privacy, labeling instructions that explain the task and provide definitions for privacy and not-privacy labels may be used. In one case, examples of tricky cases were provided (e.g., around security, scam, spam, etc.) to annotators.

In one example, each review was labeled by five annotators. Krippendorff's alpha (a reliability coefficient developed to measure the agreement among observers, coders, judges, raters, or measuring instruments) for an inter-annotator agreement was 0.455.

In one example, from the 3,254 labeled examples, a balanced test set of 300 examples (split equally between the privacy and not-privacy labels). From the remaining data, 200 items (82 of them are privacy) are used as the validation set, and the remaining 2,754 reviews (1030 of them are privacy) as the training set. Next, privacy classifier module 507 which may be a ML model, such as a T5-11B model, was trained on this training data for 500 steps (one batch per step), with a batch size of 64, a learning rate of 0.005, and a label smoothing factor of 0.1. In this model, as well as in the other described models, the final model checkpoint may be used for inference.

The 300 examples test set was used to compare the performance of the privacy classifier module 507 with two baseline models: a bag of words based SVM Classifier (using 3-5 character n-grams) and ROBERTa-Large, a 24-layer deep learning model, achieving strong results on various classification tasks. The SVM model is based on character n-grams; it does not benefit from any transfer learning. The SVM model is restricted to the patterns in the training dataset, leading to a low AUC-ROC value of 0.73, which shows the limitations of the keyword-based approach for collecting training and testing data. When evaluated on more diverse data, the SVM model does not reproduce prior performance numbers. In comparison, a classifier based on pretrained architectures, namely ROBERTa-Large, achieved significantly better performance (AUC-ROC=0.86). The T5-based classifier (AUC-ROC=0.92) leads to the best metrics (+6% vs. ROBERTa-Large and +19% vs. the SVM-based model). The ML model, even when not trained on a classification-specific architecture, is able to surpass other models that are trained on a classification-specific architecture.

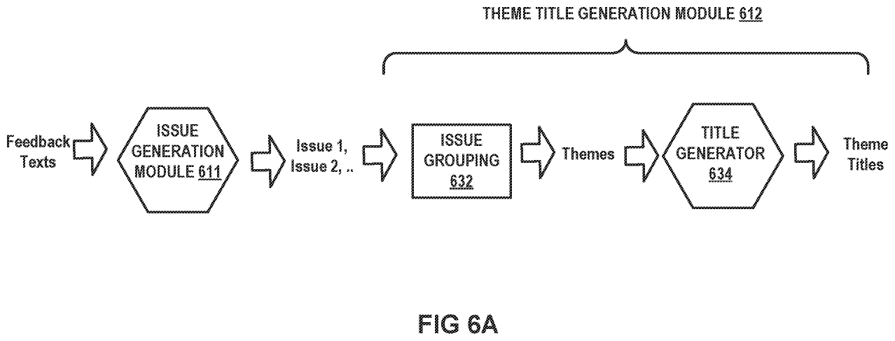

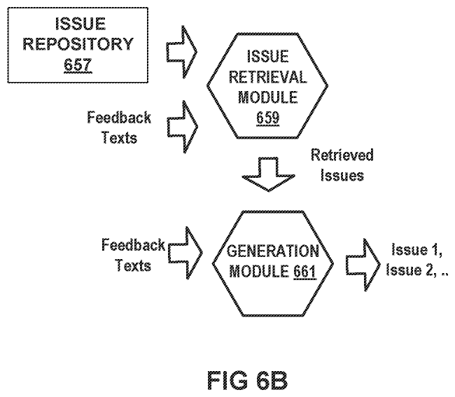

FIG. 6A is a conceptual diagram illustrating an exemplary issue generation module 611 and theme title generation module 612, in accordance with one or more techniques of this disclosure. Issue generation module 611 corresponds to issue generation module 111 of FIG. 1 and issue generation module 211 of FIG. 2. Theme title generation module 612 corresponds to theme title generation module 112 of FIG. 1 and theme title generation module 212 of FIG. 2.

Issue generation module 611 may produce fine-grained issues that users discuss in the reviews. Given a user review, the goal is to generate one or more issues summarizing the main topics that the user is discussing in the review. The term issue is used in the generic sense (i.e., it may denote both negative and positive experiences).

One approach to generate issues is to enumerate all the possible topics users might discuss (e.g., “Unnecessary Permissions”, “Data Deletion”, etc.), construct training examples for each of them, and build a classification model to tag new examples with these labels. This approach has two main limitations. First, creating training examples for each label requires a significant effort. That is why previous works on reviews' analysis have used limited taxonomies (e.g., 12 fine-grained classes). To cover all possible issues, these classes tend to be too broad. Second, the topics mentioned in the reviews evolve over time (a phenomenon called concept drift). Hence, a classification approach falls short in detecting emerging issues.

Another approach is to extract important words in the reviews and rely on these words conveying the issues. However, that would result in a set of dispersed, out-of-context quotes that do not necessarily convey the actual issues users discuss. Rather than use either of these approaches, an abstractive labeling approach may be used that combines the generalization power of abstractive models (similar to the ones used in summarization) with the familiar style of issue labels. By using the abstractive labeling approach, techniques of this disclosure may generate issues with the following features:
concise: Issues are typically 2-4 words, allowing developers to glance through a large set with minimal effort;
consistently worded: When users raise the same topic in different reviews, the issue would be expressed in an almost identical manner; and
fine-grained: Issues highlight the actual topics users discuss rather than high-level concepts, such as “bugs” or “feature requests.”

Issue generation module 611 may achieve this goal by, for example, (i) authoring a new dataset with a concise and consistent style of issues for the given reviews; and (ii) training a generative model, such as one based on T5, in a way that leads the issue generation module to behave like an abstractive summarization model rather than a classification model.

Issue generation module 611 may, in some examples, use the largest available T5 version (T5-11B) as it has been shown to have the best performance on the generative tasks compared to other model sizes. Despite attempts to diversify the reviews provided to the issue generation module 611, there are certain issues that are very prevalent in the case of feedback texts. For example, the issues “Account Hacking,” “Excessive Permissions,” and “Unneeded Contacts Access” occurred 54, 29, and 23 times respectively, in the annotated data. Allowing such frequent issues in the training data would lead the T5 model to over-generate them at inference time. Hence, the T5 model would behave like a classification model, often restricting itself to the frequent issues observed at training time. To mitigate this problem, a limit that an issue may occur, such as a maximum of two times across the whole set of training data may be imposed. The model is thus nudged to learn the task of originating issues for reviews rather than assigning from a common set of labels it has been exposed to. All the additional annotated reviews that are above that limit may be moved to the validation data. At this point, there are 613 training examples and 447 validation examples. Next, issue generation module 611, such as a T5-11B model, is trained on this data. In one example, issue generation module 611 was trained for 500 steps (one batch per step), with a batch size of 64, a learning rate of 0.005, and a label smoothing factor of 0.1.

In order to show the efficacy of issue generation module 611 in the system and to justify the major design decisions, the following models were evaluated:

An exemplary issue generation, T5-11B, model used by the present system.

T5 Wikihow: T5-11B model trained on an existing public dataset for abstractive summarization. In one example this model was trained on the on the wikiHow/sep dataset, where the task is generating section titles for sections on the website wikihow.com. This was the closest publicly available dataset to the task at hand.

RE-BERT: a state-of-the-art extractive model for identifying software requirements from app reviews. This model extracts the most relevant words/phrases from the text as the requirements as opposed to the previous abstractive models that are not bound by selecting from the input review.

To compare the various models, the newly sampled data were filtered to only keep the reviews where the models produced different sets of issues. This resulted in an evaluation set of 600 reviews.

These models were compared using two metrics:
Accuracy: An issue-level metric indicating how precise each issue is in capturing the intent of the review.
Coverage: Indicates how comprehensive a set of issues is in capturing the main topics mentioned in the review.

Human evaluation was used to evaluate the outputs of generative models, which may be more accurate than automated metrics (such as BLEU or ROUGE, which correlate the model-generated output with manually created outputs). Two human evaluation studies, one for each metric were done.

This is a highly subjective evaluation where agreement among raters is not expected to be high. Previous works have studied this extensively, showing the limitations of using traditional agreement metrics, such as Krippendorff's alpha, as those are primarily designed for objective tasks. That was not restricted to crowdsourcing but also to expert annotators. Metrics at varying levels of agreement may be used to show how the different systems fare. Previous works have used the minimum agreement level as a way to filter crowd workers' annotations.

In the first study, the review is displayed alongside one issue from each evaluated model. Annotators were asked to label each issue with one of the following choices:
Topic Discussed: The topic is discussed in the review.
Not A Topic: Contains keywords present in the review, but is not a topic.
Unrelated: Unrelated to the review.

One issue per model was selected for this experiment since accuracy is an issue-level metric. Labeling instructions explained the task. The models' order per review was shuffled so as to avoid any positional bias. Each review was annotated by seven raters.

The accuracy is reported as the percentage of cases where Topic Discussed was the most frequently chosen label (i.e., by three or more annotators out of seven). As described above, the accuracy is provided for each value of N, where N is the minimum number of annotators that chose the label. The reviews that meet that minimum agreement level were determined. The total number of reviews satisfying that level is used, not only the ones with the choice being Topic Discussed.

In the case of RE-BERT, the accuracy decreases from 28% with N=3 to 19% to N=5. It increases back to 30% when N=7. However, at N=7, the sample of reviews considered is too small to be representative (only ten reviews). With the T5 Wikihow model the accuracy increases from 56% at N=3 to 79% at N=5. This indicates that abstractive models like T5 Wikihow, even if not customized to the domain at hand, are better suited for generating the topics in the reviews compared to extractive models that select phrases from the text. The generation model's accuracy, which is customized to the review's domain, shows the full power of this approach. Its accuracy increased from a minimum of 83% at N=3 to reach 96% at N=5. Even at N=5, around 57% of the reviews are still being considered with issue generation module 111 (vs. 38% and 39% for RE-BERT and T5 Wikihow respectively). This indicates that the example system results in (1) annotators agreeing more often on its outcomes and (2) the agreement being primarily on the Topic Discussed choice. The statistical significance of the differences between each of the two models at the different agreement levels was measured using McNemar's test (a statistical test used on paired nominal data), with Bonferroni correction for multiple comparisons. The null hypothesis was that the marginal probability for the binarized outcome (Topic Discussed or not) is the same for each pair of models. The differences between issue generation module 611 and the other models are significant (p<0.05) for N∈[3, 5] vs. T5 Wikihow and for N∈[3, 6] vs. RE-BERT.

The case of N=5 has statistically significant differences, a high-level of agreement, and a considerable number of reviews. The RE-BERT model is perceived to produce keywords that are not a topic in 74% of the cases. This occurred in only 4% of the cases with an exemplary issue generation module 611. T5 Wikihow has a higher level of Unrelated issues (18%) compared to RE-BERT (6%), which is expected given that it is an out-of-domain abstractive model. The issue generation module 611, in contrast, does not have this problem and produces Unrelated outputs in only 0.3% of the cases at N=5.

In the second study evaluating the coverage metric, the review was displayed alongside the full set of issues produced by each evaluated model (as compared to a single issue per model in the accuracy evaluation). The annotators were asked to label each set of issues with one of the following choices:
Topics Covered: Label set covers the main topics mentioned in the review.
Topics Not Covered: Label set contains keywords from the review, but does not capture any main topics.
Unrelated: Label set is not related to any main topics in the review.

The coverage for the same set of 600 reviews sampled for the accuracy evaluation was evaluated. The models' order per review was randomized so as to avoid any positional bias. Each review was annotated by seven raters, and a total of 272 raters were involved.

The coverage was evaluated as the percentage of cases where Topics Covered was the most frequently chosen label (i.e., by three or more annotators out of 7). The RE-BERT model performs the worst, with the coverage consistently decreasing from 18% at N=3 to 7% at N=5 (with 45% of the reviews considered). Issue generation module 611 has coverage from 83% at N=3 to 93% at N=5 (with 60% of the reviews still considered). This indicates that, as more annotators agree, they tend to agree on the issue generation module 611 producing high coverage outputs. The differences between the issue generation module 611 and the other models are significant for N [3, 6] (p<0.05 with McNemar's test and Bonferroni correction). The null hypothesis was that the marginal probability for the binarized outcome (Topics Covered or not) is the same for each pair of models. Both RE-BERT and issue generation module 611, by design, produce multiple issue candidates from the review. RE-BERT generates 4.7 candidates on average, while our issue generation module 611 generates 2.1 on average. Hence, they are comparable in that regard. The T5 Wikihow model, on the other hand, is not trained to do so. Hence, its perceived coverage at N=3 (42%) was much lower than its accuracy (56%). These observations indicate that issue generation module 611 strikes a good balance by producing the minimal set of issues that are enough to achieve high coverage.

A plot of the case of N=5 shows that the issue generation module 611 avoids unrelated outputs (unlike the other abstractive model-T5 Wikihow) and produces issues that cover the main topics in the review.

The issue generation module 611 may be trained to generate issues for each feedback text. However, there are cases where these generated issues can be inconsistent with the feedback text. This can stem from the feedback texts being too vague and difficult to interpret or from shortcomings in the model itself. In such cases, the system may exclude such issues and reduce the noise that developers have to go through. To address this, a new classifier may give each generated issue a score indicating its consistency with the feedback texts. To train this classifier, the issue generation training data may be reused in order to create consistent and inconsistent tuples of review. A review rᵢ, with a set of issues Sᵢ, tuples {(rᵢ,s)∀s∈Si} may be assigned with the “consistent” label. Another review rₖ, with issues' set Sₖ, and tuples {(rᵢ,s)∀s∈Sₖ} may be assigned with the “inconsistent” label. The intuition is that a randomly selected review is highly unlikely to contain issues that are relevant to another review. In order to ensure this is the case, issues are indicated as inconsistent if it has a paraphrasing score less than 0.8 as computed by a machine learning model, such as a Vanilla T5-11B paraphrase detection model trained on the Microsoft Research Paraphrase Corpus (MRPC) dataset.

The problem of detecting consistent vs. inconsistent labels has similarities with the Natural Language Entailment task. To benefit from the large pre-existing data around that task, the consistency classification problem may be treated as an entailment classification problem. The user review would be the premise as explained before. The hypothesis would be formulated as “<Issue> is being discussed”. For instance, consider the review “You are selling my data to everyone”. A consistent issue “Unwanted Data Selling” would be converted to the hypothesis “Unwanted Data Selling is being discussed”. A machine learning model Vanilla T5-11B model, which has been already fine-tuned on the large MultiNLI dataset, may be further fine-tuned on the consistency data.

The input format used in MultiNLI training, which is “mnli hypothesis: <hypothesis text> premise: <review text>” may be used. The output is entailment for the consistent tuples and neutral for the inconsistent ones. In one example, the model was trained for 500 steps (one batch per step), with a batch size of 64, a learning rate of 0.005, and a label smoothing factor of 0.1.

The consistency classifier may score the outputs from the issue generation model. To generate the output of the issue generation model, one option is to use greedy decoding, where the best token is sampled at each step. This would result in a single set of issues. For instance, the review “a great game without filthy intrusive ads or privacy policy (data theft lol)”, might get “Unwanted Ads, Unwanted Privacy Policy” as the set of issues. Another option is to use beam search in order to produce the top N most probable output sequences. For a beam size of 3, the model would output three sequences (a.k.a. beam elements) ordered by their likelihood: (1) “Unwanted Ads, Unwanted Privacy Policy”, (2) “No Intrusive Ads, No Data Stealing”, and (3) “No Intrusive Ads, No Data Theft”. Each of these beam elements is composed of a set of issues Sᵢ. Using the issue generation model itself, a probability pᵢ may be assigned to each beam element overall by applying a Softmax function on the output logits. Next, any issue with a consistency (entailment) score below a threshold t is removed from the beam element i to arrive at a set of issues S′ᵢ. This allows us to avoid low quality issues. Finally, assuming that the consistency model outputs an entailment score e(s, r) for review r and issue s, an overall score for the beam element may be scored. In one example the following function is used:

$$C ( i ) = {P}_{i}^{α} \times {\sum }_{s ∈ {S}_{i}^{′}} e ( s , r ) ,$$

where α∈[0,1] is a factor for controlling the effect of the beam probabilities on the whole aggregate. The beam elements may then be re-ordered with this new score c(i), and the top set of issues S′₀ is selected. Notice that this process might end up with no issues extracted if all of them fall below the threshold t.

Theme title generation module 612 may include two stages: issue grouping 632 and title generator 634. After obtaining the issues, these issues may be grouped into themes. Issue grouping 632 may be a Leader Algorithm for clustering. Given a set of items in a certain order, this algorithm produces clusters composed of items that are within a maximum distance dmax from the cluster leader. A Leader Algorithm has several interesting properties. First, a Leader Algorithm needs only a single pass over the data, which makes is very fast. Second, the Leader Algorithm is order-dependent, which is a desired property to make high-frequency issues act as cluster leaders when issues are input based on their descending frequency order. As a distance metric within the clustering algorithm, the cosine distance between the embedding vectors of each two issues may be used. Embedding vectors may be based on the Transformer-Based Universal Sentence Encoder, which is trained on general text similarity tasks. The outcome of this stage is a set of issues acting as leaders of clusters. Each cluster practically corresponds to a high-level theme to relay to the developer. It was empirically found that dmax=0.9 is a suitable threshold for the grouping step.

A key limiting aspect of clustering alone is that it produces a long list of groups without meaningful, representative titles. The techniques of this disclosure eliminate that limitation by adding a generative model capable of taking the most frequent issues on a closely related topic and combining them into a high-level theme. Title generator 634 may be trained on a theme generation dataset.

To create a candidate dataset of issues to summarize, a subset of 200K reviews tagged as privacy by our privacy classifier is used, and issue generation module 611 and issue grouping 632 are applied. In one example, clusters with more than two issues are used, and a maximum of 10 issues per cluster are kept (keeping the most frequent issues). In one example, 570 sets of issues were selected for manual annotation. These contained 2, 171 issues (i.e., an average of 3.8 issues per set). Each set of issues was manually given a title. For instance, the set of issues: “Unable to Record Calls, Unable to Call, Unable to Receive Calls, Unable to Hear Calls, Unable to Record Caller Voice” received the title “Call Management Issues.” Because this is an open-text generation task, it was not needed to have multiple titles per set of issues (multiple annotators are used during evaluation).

Title generator 634 may use a T5-11B model. In one example, the manually annotated data may be split into 80% training data and 20% validation data. In this example, title generator 634 was trained for 500 steps (one batch per step), with a batch size of 64, a learning rate of 0.005, and a label smoothing factor of 0.1.

Title generator 634 was compared to a GPT-J 6 B model by Wang and Komatsuzaki, which is a causal language model that was shown to have strong zero-shot performance on a variety of NLP tasks. The idea is to leverage the model's ability to auto-complete text, when provided with enough context, as a way to generate theme titles. As the input to the model, a text stating four examples of issue sets as well as the expected titles is input. The last sentence of the input has a new set of issues for which the title is to be generated. In one example, GPT-J 6 B is run on this combined text, and it auto-completes with the generated theme title. This approach performed decently well. For example, it was able to generate the title “Feature Requests” for the issues “Asking for Feature, Asking for Rating, Requesting Messaging, Premium Feature Required, Asking for Visibility.”

The evaluation data was created in a similar fashion to the training data construction by starting from 1.5M examples and going through the system. It was ensured that there is no issue set in the evaluation dataset that has more than 50% overlap with any issue set in the training data. 600 issue sets from this dataset were sampled, and human evaluation was done to assess the quality of the generated titles.

A study where the annotators were given a set of issues as well as titles generated by our model (referred to as Theme-Gen) and by the baseline GPT-J in a randomized order. The instructions required the user to annotate each title with one of the following:
Title Covers: Title covers the vast majority of the labels.
Title Misses: Title misses the vast majority of the labels.
Unrelated: Title is unrelated or misrepresents the labels.

Title quality was measured as the percentage of cases where Title Covers was the most frequently chosen label (i.e., three annotators or more out of seven).

The quality of the titles generated with title generator 634 goes from around 83% at N=3 and N=4 to 92% at N=5. At N=5, 360 (i.e., 60%) of the reviews are still being considered. The GPT-J model, in contrast, has a much lower quality of 60% (at N=3) and reaches 72% at N=5. The number of reviews where the annotators agree on the decision is 49% higher with Theme-Gen than GPT-J at N=5. Hence, title generator 634 results in significantly higher quality and more annotator agreement. The differences between our theme creation model and the GPT-J are significant (p<0.05 with McNemar's test with Bonferroni correction) for N. The null hypothesis was that the marginal probability for the binarized outcome (Title Covers or not) is the same for each pair of models.

In one example, with N=5 and the percentage of reviews with each of the three choices is determined. Title generator 634 has no cases where five or more annotators perceived the title as Unrelated while this was the case in 6% of the titles produced by the GPT-J baseline. Overall, these results solidify the case for using a generative model like our theme creation model, which is finetuned on an in-domain dataset.

As previously described, by building the hierarchy of high-level themes and fine-grained issues, developers are given an easy way to track privacy issues in their applications. In order to further improve the navigability of this hierarchy, two additional models may be used one for classifying emotions in the reviews and another for classifying high vs. low-quality feedback. In both cases, existing public datasets may be leveraged by training new models on them.

The emotion classifier model builds on the GoEmotions dataset, introduced by Demszky et al. This is the largest manually annotated dataset of 58k English Reddit comments, labeled for 28 emotion categories.

The emotion classifier model, in some examples, uses the T5-11B model. Because there may be multiple emotions associated with each text in the training data, the emotion classifier model may generate a comma-separated list of classes. For example, the input to the model would be “emotion classifier: My two favorite things, The Office and The Show, combined in one reference. Life is good.”. The output would be “admiration, approval.” The original training/validation/test datasets were used. In one example, a T5-11B model was trained for 2000 steps (one batch per step), with a batch size of 64, a learning rate of 0.005, and a label smoothing factor of 0.1.

On the test set, the emotion classifier model achieves a 0.54 macro-averaged F1-score across the 28 emotions. This adds 8% in absolute macro-averaged F1 score on top of the existing BERT-based state-of-art model developed by the dataset authors.

A feedback quality model may be used for assessing a review's quality, which is designed to automatically provide representative quotes for each issue or theme. To achieve that, examples of both high and low-quality reviews may be used. For high-quality reviews, reviews that have been found to be helpful by other users may be used. This may be measured by the number of upvotes displayed next to the review. An existing publicly available dataset of reviews containing such metadata was used. From that dataset, 1,090 reviews that have five or more upvotes were extracted while ensuring diversity across the reviews' star ratings (on a scale of 1 to 5 stars). On average, the selected reviews received 27.2 upvotes.

Reviews with a low number of upvotes are not assumed to be low quality since such reviews may be simply recent or not viewed by enough users. Hence, the AR-Miner dataset by Chen et al. may be used which contains informative and non-informative reviews, manually annotated by humans. Non-informative reviews are those reflecting pure emotional expression or those that are too general or unclear. 1,090 of such reviews were used while ensuring diversity across the star ratings they are associated with. The informative reviews from AR-Miner for the positive examples were not used.

The 2,180 examples were split into 80% training and 20% testing data, and a T5-11B model was trained on a classification task using the two output labels high and low. In one example, training was run for 500 steps (one batch per step) with a batch size of 64, a learning rate of 0.005, and a label smoothing factor of 0.1. On the testing data, the feedback quality model had a performance of 99% AUC-ROC. Despite training the feedback quality model on a classification task, the probability of a high label was used as a proxy for ranking the quotes per issue/theme

FIG. 6B is a conceptual diagram illustrating an example of issue generation using an issue retrieval module 659, in accordance with one or more techniques of this disclosure. FIG. 6B shows a retrieval-augmented generation method. Issue retrieval module 659 may retrieve stored issues from an Issue Repository 657 using feedback texts. The Issue Repository 657 may store a number of previous issues such as issues extracted from a large corpus such as Wikipedia. Issue retrieval module 659 may be a machine learning model trained to retrieve the closest issues from issue repository 657 for a given feedback text. The retrieval module 659 may compare a vector created from the feedback texts with the issues vectors in the issue repository 657.

Issue retrieval module 659 may use a vectorization method using a machine learned model, such as Sentence-BERT (SBERT), with an encoder to convert previously stored issues and feedback text into vectors (arrays of a number of values). Issue retrieval module 659 may create these vectors such that the relationships between vectors reflect underlying relationships between documents, such as the stored issues and feedback texts.

The issue repository 657 may store vectors for each of the stored issues along with the stored issues. The issue retrieval module 659 may convert the feedback texts into vectors and compare them to the vectors in the issue repository 657. The issue retrieval module 659 may use comparison function, such as Euclidean distance, to compare the vectors of the stored issues and the feedback texts.

The generation module 661 may then receive the retrieved closest issues from the issue retrieval module 659 along with the feedback text. Generation module 661 may decide whether to use one of the retrieved issues or whether it should generate a new issue. By showing the generation module 661 the existing issues, the system avoids generating redundant issues that are equivalent. This helps better account for the frequency of each issue.

Generator module 661 may be trained in a similar manner as issue generation module 611 of FIG. 6A but using an expanded input including the retrieved closest issues as well as the feedback texts. Generator module 661 may use a machine learning model such as a natural language processing (NLP) model (e.g., a transformer model, a recurrent neural network (RNN) model, etc.). For example, generator module 661 may use a T5 model, such as a T5-11B model.

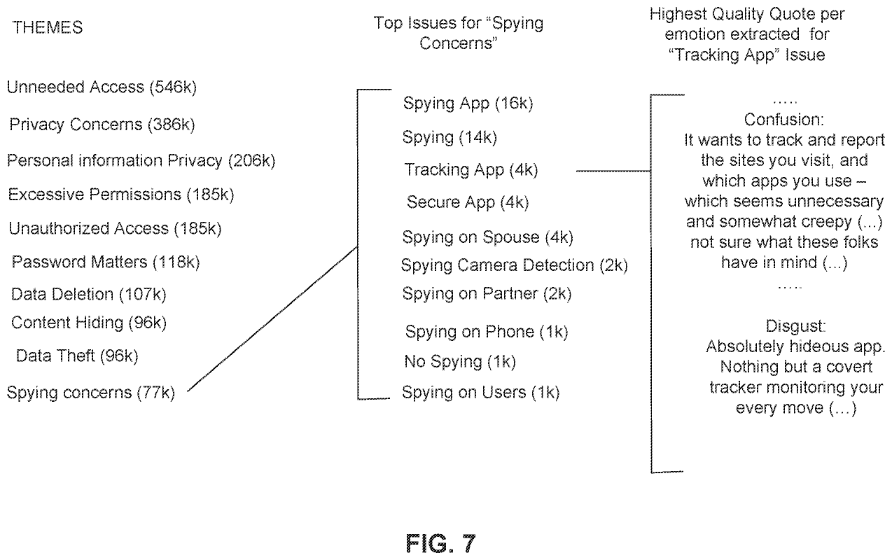

FIG. 7 is a conceptual diagram illustrating an example of the hierarchy produced by a system implementing one or more techniques of this disclosure. At the top level, the top 10 identified themes are shown. The themes are associated with a variety of emotions; for instance, the “Unneeded Access” theme has a volume of 546,000 reviews, 42% of which are associated with Anger and 23% with Confusion.

The diversity across these ten themes gives a glimpse of our system's ability to cover a rich set of privacy topics, ranging from “Excessive Permissions” to “Content hiding”. Across the whole set of reviews, the system generated over 300 high-level themes that had at least 1,000 reviews. Of these, the smallest theme covered about 15 fine-grained issues, whereas the largest one covered over 1,000 fine-grained issues.

The emotions dimension provides an important tool for navigability. Unlike previous works that focused on negative privacy issues, the techniques of the present disclosure uncovered a lot of content associated with positive emotions. An example is the “Content Hiding” theme, where users are pleased with privacy controls that enable functionalities such as hiding videos and locking photos. The emotions filter also provides developers with a new way to prioritize what to tackle first—as they could select issues with a much high anger representation over those with the highest volume.

In one example, the “Spying Concerns” theme shows the top 10 fine-grained issues. This showcases how the system turned 77,000 reviews in this theme into an easily-glanceable set of fine-grained issues. While users express an elevated level of “Anger” (34%) towards “Spying” (typically general mentions of spying actions), they do not shy away from expressing joy at “No Spying” (even if the latter is of a smaller volume). Surprisingly, the “Spying on Spouse” issue is dominated by “joy” emotions, indicating that this is a highly appreciated feature. This illustrates the potential for the system to also be used as a powerful tool by people interested in other topics and non-privacy-related feedback text information.

FIG. 7 also illustrates an additional level of navigability that helps developers (or researchers) to understand specific fine-grained issues, in detail, from the users' perspective, by observing a small set of high-quality quotes (surfaced by our system's quality classifier). These quotes may be further diversified across the emotions dimension. For instance, a developer may see from the review associated with the Disgust emotion that users are uninstalling the app due to concerns around tracking. Alternatively, developers could learn about users' Desire for the app to not track their email or private information. In the example of FIG. 7, a high-quality feedback text associated with the confusion emotion is shown.

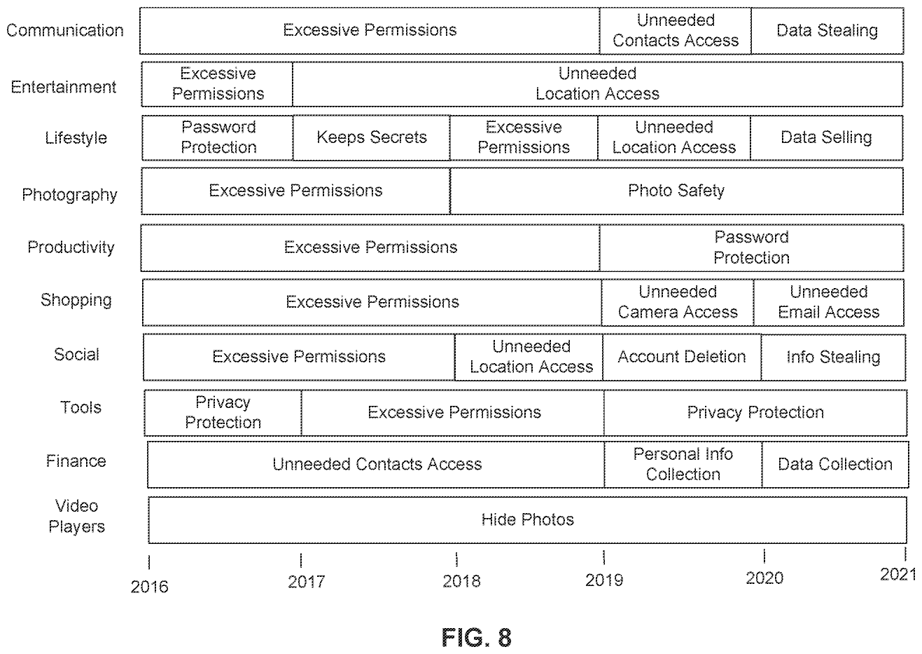

FIG. 8 is a conceptual diagram illustrating the evolution of issues over time, in accordance with one or more techniques of this disclosure. The example shown in FIG. 8 includes common fine-grained issues for the top 10 application categories in the last five years. Interestingly, the issue of excessive permissions was dominant across various app categories during 2016-2018. Recently, the dominant issues pivoted towards various types of unneeded access (contacts, location, camera, etc.) as well as data selling/stealing. Developers could analyze these trends in order to correlate them with app or policy changes.

As described above with respect to privacy content of feedback texts, techniques of this disclosure may be used to understand temporal trends in privacy issues, to compare issues based on the emotions dimension, to analyze the type of feedback that leads users to uninstall apps, to explore particular themes of interest (e.g., “Blackmailing Concerns,” “Financial Privacy,” “Audio Surveillance,” “Parental Controls,” etc.), security, etc. Temporal insights may provide developers with a valuable sense of the progress they made and may also help provide developers with concrete ideas for improving their applications.

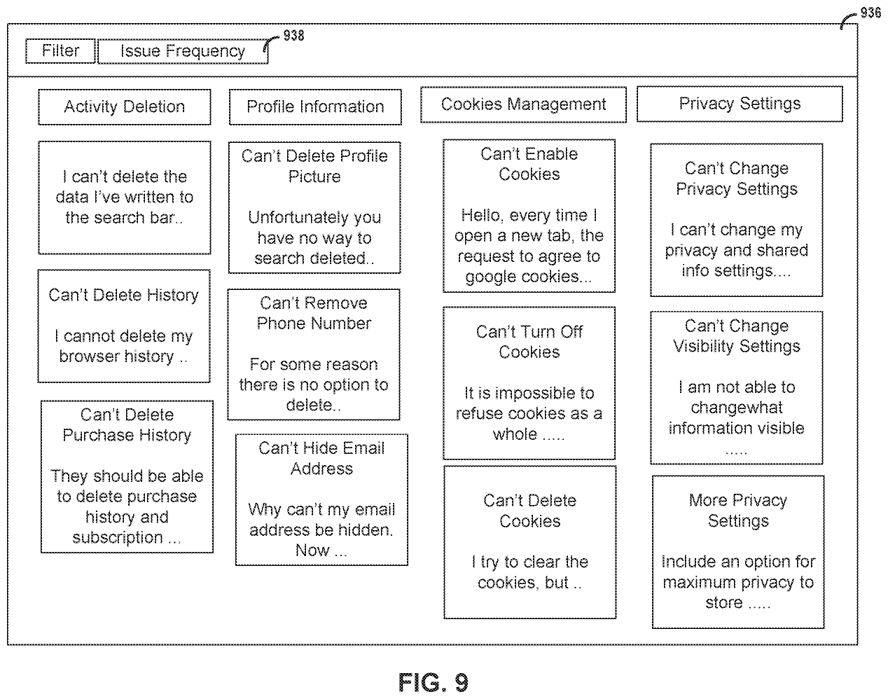

FIG. 9 is a conceptual diagram illustrating an example graphical user interface (GUI) 936 that includes information generated by analyzing feedback texts in accordance with one or more techniques of this disclosure. Graphical user interface 936 may implement GUI 142 at display device 140 of FIG. 1.

The example graphical user interface of FIG. 9 is a tabbed user interface that includes a first tab for showing fine-grained issues, a second tab for showing high-level issues, and a third tab for adding additional tables of information. The graphical user interface shows the fine-grained issues tab as the active tab. The fine-grained issues tab includes high-level issues “Activity Deletion,” “Profile Information Management,” “Cookies Management,” and “Privacy Settings,” where, within each high-level issue, the graphical user interface includes one or more fine-grained issues such as “Can't Delete History,” “Can't Remove Phone Number,” “More Privacy Setting,” etc. The high-level issues (i.e., themes), fine-grained issues, representative feedback text comments and other information included within the graphical user interface may be generated by one or more modules 207-222 of computing device 202 of FIGS. 2, as described above.

GUI 936 may include input field 938 to filter displayed reviews. For example, input field 938 may filter displayed feedback texts by emotion, quality, and/or frequency.

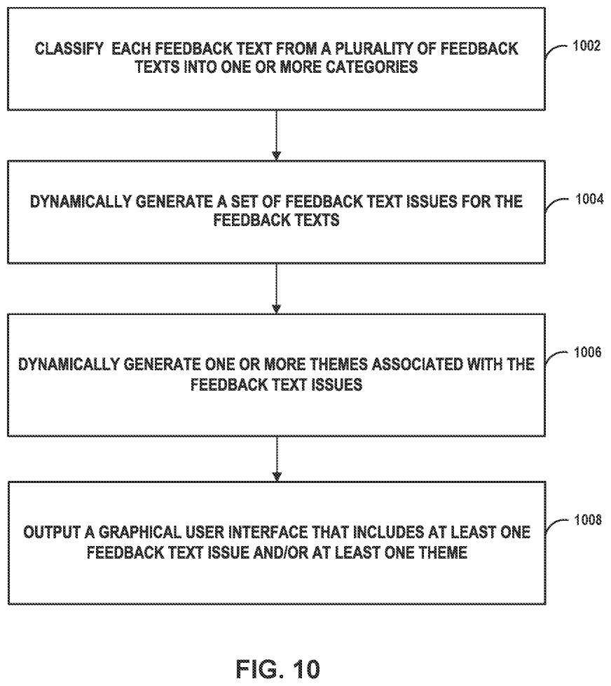

FIG. 10 is a flow diagram illustrating example operations of a process 1000 that is performed by a computing system in accordance with one or more aspects of the present disclosure. For purposes of illustration only, the operations of FIG. 10 are described below within the context of computing system 101 of FIG. 1.

Computing system 101 may classify each feedback text from a plurality of feedback texts into one or more categories (1002). For example, computing system 101 may classify feedback texts as being related to privacy or as being not related to privacy. Computing system 101 may also classify each feedback text into other categories such as security and accessibility.

Computing system 101 may dynamically generate a set of feedback text issues for the feedback texts. (1004). The set of feedback text issues may include one or more issues associated with each feedback text from the plurality of feedback texts. Such feedback text issues may be more concise than full feedback texts and thus easier to be quickly understood.

Computing system 101 may dynamically generate one or more themes associated with the review issues (1006). Each of the one or more themes may be associated with a respective subset of feedback text issues from the set of feedback text issues. The themes may group together one or more feedback text issues and use a shared theme title.

Computing system 101 may output a graphical user interface, such that includes at least one feedback text issue and/or at least one theme (1008). The graphical user interface may include one or more from the group consisting of: at least one feedback text issue from the set of feedback text issues, and at least theme from the one or more themes Graphical user interface (GUI) 142 at display device 140 may use the issues and/or themes to display feedback texts in a structured manner allowing application designers to understand the feedback texts better.

This disclosure includes the following examples.

Example 1: A method comprising: classifying, by a computing system, each feedback text from a plurality of feedback texts into one or more categories; dynamically generating, by the computing system and using the plurality of feedback texts, a set of feedback text issues, wherein the set of feedback text issues includes one or more issues associated with each feedback text from the plurality of feedback texts; dynamically generating, by the computing system and using the set of feedback text issues, one or more themes associated with the plurality of feedback texts, wherein each of the one or more themes is associated with a respective subset of feedback text issues from the set of feedback text issues; and outputting, by the computing system and for display, a graphical user interface that includes one or more from the group consisting of: at least one feedback text issue form the set of feedback text issues, and at least theme from the one or more themes.

Example 2: The method of example 1, further comprising: classifying, by the computing system, each feedback text issue from the set of feedback text issues into one emotion classification from a set of emotion classifications; classifying, by the computing system, each theme from the one or more themes into one emotion classification from the set of emotion classifications, wherein the graphical user interface further includes at least one emotion classification from the set of emotion classifications.

Example 3: The method of example 2, wherein classifying each feedback text issue into the one emotion classification includes providing, by the computing system, each respective feedback text issue from the set of feedback text issues as input to an emotion classifier model; and receiving, by the computing system and from the emotion classifier model, the one emotion classification associated with the respective feedback text issue.

Example 4: The method of any of examples 1 to 3, further comprising: ranking, by the computing system, one or more feedback text quotes associated with each of the one or more issues into a set of ranked feedback text quotes associated with a respective issue from the one or more issues; selecting, by the computing system and based on the ranking, at least one of the one or more feedback text quotes as a selected feedback text quote, wherein the graphical user interface further includes the selected feedback text quote.

Example 5: The method of any of examples 1 to 4, wherein ranking the one or more feedback text quotes associated with each of the one or more issues includes providing, by the computing system, each respective feedback text quote from one or more feedback text quotes associated with the respective issue as input to a feedback quality model; and receiving, by the computing system and from the feedback quality model, a respective ranking for each of the one or more review quotes.

Example 6: The method of any of examples 1 to 5, further comprising: classifying, by the computing system, each feedback text from the plurality of feedback texts as being junk or not junk; filtering, by the computing system and based on the classification of each of the feedback texts, the plurality of feedback texts into a set of filtered feedback texts, wherein the set of filtered feedback texts only includes feedback texts from the plurality of feedback texts classified as being not junk.

Example 7: The method of any of examples 1 to 5, further comprising: classifying, by the computing system, each feedback text from a superset of feedback texts as being junk or not junk, wherein the plurality of feedback texts are included in the superset of feedback texts; filtering, by the computing system and based on the classification of each of the feedback texts, the superset of feedback texts to generate the plurality of feedback texts, wherein the plurality of feedback texts only includes feedback texts from the superset of feedback texts classified as being not junk.

Example 8: The method of any of examples 1 to 7, wherein classifying each feedback text from the plurality of feedback texts into one or more categories includes providing, by the computing system, each respective feedback text from the plurality of feedback texts as input to a feedback classifier model; and receiving, by the computing system and from the feedback classifier model, the one or more categories associated with the respective feedback text.

Example 9: The method of any of examples 1 to 8, wherein dynamically generating the set of feedback text issues includes providing, by the computing system, the plurality of feedback texts as input to an issue generation model; and receiving, by the computing system and from the issue general model, the set of feedback text issues.

Example 10: The method of any of examples 1 to 9, wherein the set of feedback text issues is not generated using a predetermined set of feedback text issues.

Example 11: The method of any of examples 1 to 10, wherein dynamically generating the one or more themes associated with the plurality of feedback texts includes providing, by the computing system, the set of feedback text issues as input to a theme creation model; and receiving, by the computing system and from the theme creation model, the one or more themes.

Example 12: The method of any of examples 1 to 11, wherein the one or more themes are not generated using a predetermined set of themes.

Example 13: The method of any of the examples 1 to 12 wherein the feedback texts are application reviews.

Example 14 The method of any of the examples 1 to 13 wherein the dynamically generating the set of feedback text issues includes comparing the feedback texts to stored issues to retrieve stored issues and using the retrieved stored issues to generate the set of feedback text issues along with the feedback texts.

Example 15: A computing system comprising means for performing any combination of the methods of examples 1-14.

Example 16: A non-transitory computer-readable medium encoded with instructions for performing any combination of the methods of examples 1-14.

Example 17. A computing device, comprising a memory; and at least one processor communicably coupled to the memory and configured to: classify each feedback text from a plurality of feedback texts into one or more categories; dynamically generate using the plurality of feedback texts, a set of feedback text issues, wherein the set of feedback text issues includes one or more issues associated with each feedback text from the plurality of feedback texts; dynamically generate, by the computing system and using the set of feedback text issues, one or more themes associated with the plurality of feedback texts, wherein each of the one or more themes is associated with a respective subset of feedback text issues from the set of feedback text issues; and output, by the computing system and for display, a graphical user interface that includes one or more from the group consisting of: at least one feedback text issue form the set of feedback text issues, and at least theme from the one or more themes.

Example 18: The computing device of example 17, the at least one processor are further configured to classify, by the computing system, each feedback text issue from the set of feedback text issues into one emotion classification from a set of emotion classifications; classify, by the computing system, each theme from the one or more themes into one emotion classification from the set of emotion classifications, wherein the graphical user interface further includes at least one emotion classification from the set of emotion classifications.

Example 19: The computing device of examples 17-18, wherein the at least one processor is configured to classify each feedback text issue into the one emotion classification by providing each respective feedback text issue from the set of feedback text issues as input to an emotion classifier model; and receive from the emotion classifier model the one emotion classification associated with the respective feedback text issue.

Example 20: The computing device of any of examples 17-19, wherein the at least one processor is further configured further comprising: ranking, by the computing system, one or more feedback text quotes associated with each of the one or more issues into a set of ranked feedback text quotes associated with a respective issue from the one or more issues; selecting, by the computing system and based on the ranking, at least one of the one or more feedback text quotes as a selected feedback text quote, wherein the graphical user interface further includes the selected feedback text quote.

Example 21: The computing device of any of examples 17-20, wherein the at least one processor is further configured to rank the one or more feedback text quotes associated with each of the one or more issues including providing each respective feedback text quote from one or more feedback text quotes associated with the respective issue as input to a feedback quality model; and receiving, by the computing system and from the feedback quality model, a respective ranking for each of the one or more review quotes.

Example 22: The computing device of any of examples 17-21, wherein the at least one processor is further configured to classify each feedback text from the plurality of feedback texts as being junk or not junk; filter based on the classification of each of the feedback texts, the plurality of feedback texts into a set of filtered feedback texts, wherein the set of filtered feedback texts only includes feedback texts from the plurality of feedback texts classified as being not junk.

Example 23: The computing device of any of examples 17-21, wherein the at least one processor is further configured to classify each feedback text from a superset of feedback texts as being junk or not junk, wherein the plurality of feedback texts are included in the superset of feedback texts; and configured to filter based on the classification of each of the feedback texts the superset of feedback texts to generate the plurality of feedback texts, wherein the plurality of feedback texts only includes feedback texts from the superset of feedback texts classified as being not junk.

Example 24: The computing device of any of examples 17-23, wherein the at least one processor is configured to classify each feedback text from the plurality of feedback texts into one or more categories by providing, by the computing system, each respective feedback text from the plurality of feedback texts as input to a feedback classifier model; and receiving, by the computing system and from the feedback classifier model, the one or more categories associated with the respective feedback text.

Example 25: The computing device of any of examples 17-24, wherein the at least one processor is configured to dynamically generate the set of feedback text issues by providing the plurality of feedback texts as input to an issue generation model; and receive from the issue general model, the set of feedback text issues.

Example 26: The computing device of any of examples 17-25, wherein the set of feedback text issues is not generated using a predetermined set of feedback text issues.

Example 27: The computing device of any of examples 17-26, wherein the at least one processor is configured to dynamically generate the one or more themes associated with the plurality of feedback texts including providing the set of feedback text issues as input to a theme creation model; and to receive from the theme creation model the one or more themes.

Example 28: The computing device of any of the examples 15 to 27 wherein the feedback texts are application reviews.

Example 29: The computing device of any of the examples 15 to 28 wherein the at least one processor is configured to dynamically generate the set of feedback text issues by comparing the feedback texts to stored issues to retrieve stored issues and using the retrieved stored issues to generate the set of feedback text issues along with the feedback texts.

Example 30. A computer-readable storage medium having stored thereon instructions that, when executed, cause at least one processor of a computing device to classify each feedback text from a plurality of feedback texts into one or more categories; dynamically generate using the plurality of feedback texts, a set of feedback text issues, wherein the set of feedback text issues includes one or more issues associated with each feedback text from the plurality of feedback texts; dynamically generate, by the computing system and using the set of feedback text issues, one or more themes associated with the plurality of feedback texts, wherein each of the one or more themes is associated with a respective subset of feedback text issues from the set of feedback text issues; and output, by the computing system and for display, a graphical user interface that includes one or more from the group consisting of: at least one feedback text issue form the set of feedback text issues, and at least theme from the one or more themes.

Example 31: The computer-readable storage medium of example 30 having stored thereon instructions that, when executed, cause at least one processor of a computing device to classify, by the computing system, each feedback text issue from the set of feedback text issues into one emotion classification from a set of emotion classifications; classify, by the computing system, each theme from the one or more themes into one emotion classification from the set of emotion classifications, wherein the graphical user interface further includes at least one emotion classification from the set of emotion classifications.

Example 32: The computer-readable storage medium of example 30-31 having stored thereon instructions that, when executed, cause at least one processor of a computing device to classify each feedback text issue into the one emotion classification by providing each respective feedback text issue from the set of feedback text issues as input to an emotion classifier model; and receive from the emotion classifier model the one emotion classification associated with the respective feedback text issue.

Example 33: The computer-readable storage medium of any of examples 30-32 having stored thereon instructions that, when executed, cause at least one processor of a computing device to ranking, by the computing system, one or more feedback text quotes associated with each of the one or more issues into a set of ranked feedback text quotes associated with a respective issue from the one or more issues; selecting, by the computing system and based on the ranking, at least one of the one or more feedback text quotes as a selected feedback text quote, wherein the graphical user interface further includes the selected feedback text quote.

Example 34: The computer-readable storage medium of any of examples 30-33, having stored thereon instructions that, when executed, cause at least one processor of a computing device to rank the one or more feedback text quotes associated with each of the one or more issues including providing each respective feedback text quote from one or more feedback text quotes associated with the respective issue as input to a feedback quality model; and receiving, by the computing system and from the feedback quality model, a respective ranking for each of the one or more review quotes.

Example 35: The computer-readable storage medium of any of examples 30-34, having stored thereon instructions that, when executed, cause at least one processor of a computing device to classify each feedback text from the plurality of feedback texts as being junk or not junk; filter based on the classification of each of the feedback texts, the plurality of feedback texts into a set of filtered feedback texts, wherein the set of filtered feedback texts only includes feedback texts from the plurality of feedback texts classified as being not junk.

Example 36: The computer-readable storage medium of any of examples 30-34, having stored thereon instructions that, when executed, cause at least one processor of a computing device to classify each feedback text from a superset of feedback texts as being junk or not junk, wherein the plurality of feedback texts are included in the superset of feedback texts; and configured to filter based on the classification of each of the feedback texts the superset of feedback texts to generate the plurality of feedback texts, wherein the plurality of feedback texts only includes feedback texts from the superset of feedback texts classified as being not junk.

Example 37: The computer-readable storage medium of any of examples 30-36, having stored thereon instructions that, when executed, cause at least one processor of a computing device to classify each feedback text from the plurality of feedback texts into one or more categories by providing, by the computing system, each respective feedback text from the plurality of feedback texts as input to a feedback classifier model; and receiving, by the computing system and from the feedback classifier model, the one or more categories associated with the respective feedback text.

Example 38: The computer-readable storage medium of any of examples 30-37, having stored thereon instructions that, when executed, cause at least one processor of a computing device to dynamically generate the set of feedback text issues by providing the plurality of feedback texts as input to an issue generation model; and receive from the issue general model, the set of feedback text issues.

Example 39: The computer-readable storage medium of any of examples 30-38, wherein the set of feedback text issues is not generated using a predetermined set of feedback text issues.

Example 40: The computer-readable storage medium of any of examples 30-39, having stored thereon instructions that, when executed, cause at least one processor of a computing device to dynamically generate the one or more themes associated with the plurality of feedback texts including providing the set of feedback text issues as input to a theme creation model; and to receive from the theme creation model the one or more themes.

Example 41: The computer-readable storage medium of any of examples 30 to 40 wherein the feedback texts are application reviews.

Example 42: The computer-readable storage medium of any of examples 30-41 having stored thereon instructions that, when executed, cause at least one processor of a computing device to dynamically generate the set of feedback text issues by comparing the feedback texts to stored issues to retrieve stored issues and using the retrieved stored issues to generate the set of feedback text issues along with the feedback texts.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other storage medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of intraoperative hardware units, including one or more processors as described above, in conjunction with suitable software and/or firmware.

It is to be recognized that, depending on the embodiment, certain acts or events of any of the methods described herein may be performed in a different sequence, may be added, merged, or left out altogether (e.g., not all described acts or events are necessary for the practice of the method). Moreover, in certain embodiments, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

1. A method comprising:
classifying, by a computing system, each feedback text from a plurality of feedback texts into one or more categories;
dynamically generating, by the computing system and using the plurality of feedback texts, a set of feedback text issues, wherein the set of feedback text issues includes one or more issues associated with each feedback text from the plurality of feedback texts;
dynamically generating, by the computing system and using the set of feedback text issues, one or more themes associated with the plurality of feedback texts, wherein each of the one or more themes is associated with a respective subset of feedback text issues from the set of feedback text issues; and
outputting, by the computing system and for display, a graphical user interface that includes one or more from the group consisting of: at least one feedback text issue from the set of feedback text issues, and at least theme from the one or more themes.

2. The method of claim 1, further comprising:
classifying, by the computing system, each feedback text issue from the set of feedback text issues into one emotion classification from a set of emotion classifications; and
classifying, by the computing system, each theme from the one or more themes into one emotion classification from the set of emotion classifications, wherein the graphical user interface further includes at least one emotion classification from the set of emotion classifications.

3. The method of claim 2, wherein classifying each feedback text issue into the one emotion classification further comprises
providing, by the computing system, each respective feedback text issue from the set of feedback text issues as input to an emotion classifier model; and
receiving, by the computing system and from the emotion classifier model, the one emotion classification associated with the respective feedback text issue.

4. The method of claim 1, further comprising:
ranking, by the computing system, one or more feedback text quotes associated with each of the one or more issues into a set of ranked feedback text quotes associated with a respective issue from the one or more issues; and
selecting, by the computing system and based on the ranking, at least one of the one or more feedback text quotes as a selected feedback text quote, wherein the graphical user interface further includes the selected feedback text quote.

5. The method of claim 4, wherein ranking the one or more feedback text quotes associated with each of the one or more issues further comprising
providing, by the computing system, each respective feedback text quote from one or more feedback text quotes associated with the respective issue as input to a feedback quality model; and
receiving, by the computing system and from the feedback quality model, a respective ranking for each of the one or more feedback text quotes.

6. The method of claim 1, further comprising:
classifying, by the computing system, each feedback text from the plurality of feedback texts as being junk or not junk; and
filtering, by the computing system and based on the classification of each of the feedback texts, the plurality of feedback texts into a set of filtered feedback texts, wherein the set of filtered feedback texts only includes feedback texts from the plurality of feedback texts classified as being not junk.

7. The method of claim 1, further comprising:
classifying, by the computing system, each feedback text from a superset of feedback texts as being junk or not junk, wherein the plurality of feedback texts are included in the superset of feedback texts; and
filtering, by the computing system and based on the classification of each of the feedback texts, the superset of feedback texts to generate the plurality of feedback texts,
wherein the plurality of feedback texts only includes feedback texts from the superset of feedback texts classified as being not junk.

8. The method of claim 1, wherein classifying each feedback text from the plurality of feedback texts into one or more categories further comprises:
providing, by the computing system, each respective feedback text from the plurality of feedback texts as input to a feedback classifier model; and
receiving, by the computing system and from the feedback classifier model, the one or more categories associated with the respective feedback text.

9. The method of claim 1, wherein dynamically generating the set of feedback text issues further comprises:
providing, by the computing system, the plurality of feedback texts as input to an issue generation model; and
receiving, by the computing system and from the issue general model, the set of feedback text issues.

10. The method of claim 1, wherein the set of feedback text issues is not generated using a predetermined set of feedback text issues.

11. The method of claim 1, wherein dynamically generating the one or more themes associated with the plurality of feedback texts further comprises
providing, by the computing system, the set of feedback text issues as input to a theme creation model; and
receiving, by the computing system and from the theme creation model, the one or more themes.

12. The method of claim 1, wherein the one or more themes are not generated using a predetermined set of themes.

13. The method of claim 1, wherein the feedback texts are application reviews.

14. The method of claim 1, wherein dynamically generating the set of feedback text issues includes comparing the feedback texts to stored issues to retrieve stored issues and using the retrieved stored issues to generate the set of feedback text issues along with the feedback texts.

15-16. (canceled)

17. A computing system, comprising:
a memory; and
at least one processor communicably coupled to the memory and configured to:
classify each feedback text from a plurality of feedback texts into one or more categories;
dynamically generate using the plurality of feedback texts, a set of feedback text issues, wherein the set of feedback text issues includes one or more issues associated with each feedback text from the plurality of feedback texts;
dynamically generate, by the computing system and using the set of feedback text issues, one or more themes associated with the plurality of feedback texts, wherein each of the one or more themes is associated with a respective subset of feedback text issues from the set of feedback text issues; and
output, by the computing system and for display, a graphical user interface that includes one or more from the group consisting of: at least one feedback text issue from the set of feedback text issues, and at least theme from the one or more themes.

18. The computing system of claim 17, wherein the at least one processor is further configured to:
classify each feedback text issue from the set of feedback text issues into one emotion classification from a set of emotion classifications; and
classify each theme from the one or more themes into one emotion classification from the set of emotion classifications,
wherein the graphical user interface further includes at least one emotion classification from the set of emotion classifications.

19. The computing system of claim 17, wherein the at least one processor is further configured to:
classify each feedback text from a superset of feedback texts as being junk or not junk, wherein the plurality of feedback texts are included in the superset of feedback texts; and
filter, based on the classification of each of the feedback texts, the superset of feedback texts to generate the plurality of feedback texts,
wherein the plurality of feedback texts only includes feedback texts from the superset of feedback texts classified as being not junk.

20. A computer-readable storage medium having stored thereon instructions that, when executed, cause at least one processor of a computing device to:
classify each feedback text from a plurality of feedback texts into one or more categories;
dynamically generate using the plurality of feedback texts, a set of feedback text issues, wherein the set of feedback text issues includes one or more issues associated with each feedback text from the plurality of feedback texts;
dynamically generate, using the set of feedback text issues, one or more themes associated with the plurality of feedback texts, wherein each of the one or more themes is associated with a respective subset of feedback text issues from the set of feedback text issues; and
output, for display, a graphical user interface that includes one or more from the group consisting of: at least one feedback text issue form the set of feedback text issues, and at least theme from the one or more themes.

21. The computer-readable storage medium of claim 20, wherein the instructions further cause the at least one processor to:
classify each feedback text issue from the set of feedback text issues into one emotion classification from a set of emotion classifications; and
classify each theme from the one or more themes into one emotion classification from the set of emotion classifications,
wherein the graphical user interface further includes at least one emotion classification from the set of emotion classifications.

22. The computer-readable storage medium of claim 20, wherein the instructions further cause the at least one processor to:
classify each feedback text from a superset of feedback texts as being junk or not junk, wherein the plurality of feedback texts are included in the superset of feedback texts; and
filter, based on the classification of each of the feedback texts, the superset of feedback texts to generate the plurality of feedback texts,
wherein the plurality of feedback texts only includes feedback texts from the superset of feedback texts classified as being not junk.
